(19) United States
(12) Patent Application Publication
(10) Pub. No.: US 2017/0116586 A1
(43) Pub. Date: Apr. 27, 2017

(54) AUTOMATIC TRANSACTION DEVICE AND PROGRAM THEREOF

(71) Applicant: Oki Electric Industry Co., Ltd., Tokyo (JP)

(72) Inventor: Tomonori MIMURA, Tokyo (JP)

(73) Assignee: Oki Electric Industry Co., Ltd., Tokyo (JP)

(21) Appl. No.: 15/112,790

(22) PCT Filed: Dec. 17, 2014
(86) PCT No.: PCT/JP2014/083422

§ 371 Date: Jul. 20, 2016

(30) Foreign Application Priority Data
Mar. 27, 2014 (JP) 2014-067257

(51) Int. Cl. G06Q 20/10; G07D 7/12; G07F 19/00; G07D 11/00

(52) U.S. Cl. CPC G06Q 20/1085; G07D 11/0018; G07D 11/0021; G07D 7/128; G07F 19/202; G06Q 20/102

(57) ABSTRACT

An automatic transaction device, that communicates with a host computer and executes various types of transaction processings, includes: a media insert port into which media are inserted; a conveying section that conveys media, that have been inserted in the media insert port, from the media insert port to predetermined places; a discriminating section that identifies whether a conveyed medium is a bill or is a transaction medium, and, when the medium is identified to be a bill, recognizes a denomination thereof, and, on the other hand, when the medium is identified to be a transaction medium, recognizes stated contents thereof; and a control section that executes a transaction processing on the basis of the stated contents that the discriminating section recognized.

### TECHNICAL FIELD

The present invention relates to an automatic transaction device (ATM) that communicates with a host computer and executes various types of transaction processings, and to a program, and in particular, a program that causes execution by a control section or a discriminating section of the automatic transaction device.

### BACKGROUND ART

Systems that, by using a transaction medium called a “transfer form”, a “payment form”, a “check” or the like for example, execute transfer (payment) transaction processings of various types of fees for electricity, gas and others to an enterprise, and execute deposit transaction processings, have come into wide use in recent years.

This type of system is realized by, for example, using a cash register, that is set in a convenience store or the like, as a terminal device. In this system, a transfer transaction processing is executed by, for example, the remitter (the payer) bringing a transaction medium to the convenience store and handing the transaction medium over to a clerk at the convenience store. When the clerk receives the transaction medium from the remitter, the clerk operates a barcode reader connected to the cash register and causes the barcode information that is printed on the transaction medium to be read. When the barcode reader reads the barcode information, the barcode reader outputs the barcode information to the cash register. When the barcode information is inputted to the cash register, on the basis of the barcode information, various types of information stated on the transaction medium (e.g., information specifying the remitter, and information such as the name of the payee, the account of the payee, the amount to be transferred (the invoiced amount) and the like) is specified, and the amount to be transferred is displayed on a display portion. In accordance therewith, the remitter gives the clerk cash in the amount of the amount to be transferred. When the clerk receives the cash in the amount of the amount to be transferred from the remitter, the clerk instructs the cash register to execute the transfer transaction processing. The transfer transaction processing is thereby executed. However, in this system, the transfer transaction processing is executed by the manual operation of the clerk, and therefore, it is desirable to reduce to the work of the clerk.

Thus, it has been proposed to, in such a system, utilize an automatic transaction device (an ATM), that is set in a financial institution or a distribution institution such as a bank, a post office, a convenience store, a shopping mall or the like for example, as a terminal device, and for the remitter to execute the transfer transaction processing by operating the automatic transaction device. In such a system, the automatic transaction device is structured to have, at the interior thereof, a recognizing section (a transfer form reading/printing section) that recognizes the stated contents of the transaction medium. At this automatic transaction device, the recognizing section acquires an image of the transaction medium, and, by executing optical character recognition processing (OCR processing) on the acquired image of the transaction medium, specifies the stated contents of the transaction medium, and, on the basis of the stated contents of the transaction medium, automatically executes the transfer transaction processing (see, for example, Japanese Patent Application Laid-Open (JP-A) No. H05-204957 (Patent Document 1)).

### SUMMARY OF INVENTION

### Technical Problem

However, in a conventional automatic transaction device, there was the need to provide structural elements exclusively used for handling transaction media (e.g., an insert port exclusively used for the insertion of a transaction medium into the device, a recognizing section exclusively used for recognizing the stated contents of the transaction medium, a conveying section or conveying path exclusively used for conveying the transaction medium from the insert port to the recognizing section or accommodating section, and the like). Therefore, the conventional automatic transaction device had the problems that the manufacturing cost thereof increased, and the cost thereof became expensive.

Further, because the number of insert ports increased at the conventional automatic transaction device, it was difficult to know which of the insert ports a transaction medium should be inserted into, and, as a result, there was the problem that it was easy for the operation time of the device monopolized per remitter (operator) to become long. Widespread use of conventional automatic transaction devices has been impeded due to these problems.

The present invention was made in order to overcome the above-described problems, and a main object thereof is to provide an automatic transaction device having a reduced number of structural elements that are exclusively used for handling a transaction medium, and a program thereof.

### Solution to Problem

In order to achieve the above-described object, a first invention is an automatic transaction device that communicates with a host computer and executes various types of transaction processings, comprising: a media insert port into which media are inserted; a conveying section that conveys media that have been inserted in the media insert port; a discriminating section that identifies whether the conveyed medium is a bill or is a transaction medium, and, when the medium is identified to be a bill, recognizes a denomination thereof, and, on the other hand, when the medium is identified to be a transaction medium, recognizes stated contents thereof; and a control section that executes a transaction processing on the basis of the stated contents that the discriminating section recognized.

This automatic transaction device is a mechanism that handles bills, and can also handle transaction media (a “transfer form” or a “payment form”, a “check” or the like). Therefore, the automatic transaction device can reduce the number of structural elements that were provided at a conventional automatic transaction device and are exclusively used for handling a transaction medium (e.g., an insert port exclusively used for the insertion of a transaction medium into the device, a recognizing section exclusively used for recognizing the stated contents of the transaction medium, a conveying section and a conveying path exclusively used for conveying the transaction medium from the insert port to the recognizing section, and the like). Due thereto, the automatic transaction device can suppress an increase in the manufacturing cost.

Further, by making the bills and the transaction medium be inserted into the same insert port, the automatic transaction device can avoid an increase in the number of insert ports. Therefore, it is easy to understand which insert port the transaction medium should be inserted into, and the operation time of the device monopolized per remitter (operator) can be shortened.

Further, a second invention is a program that causes execution by a control section of an automatic transaction device that communicates with a host computer and executes various types of transaction processings and includes a media insert port into which media are inserted, a conveying section that conveys media that have been inserted in the media insert port, a discriminating section that identifies whether the conveyed medium is a bill or is a transaction medium, and, when the medium is identified to be a bill, recognizes a denomination thereof, and, on the other hand, when the medium is identified to be a transaction medium, recognizes stated contents thereof, and the control section that executes a transaction processing, wherein the program is structured to cause the control section to compute a total amount of media that have been identified as bills by the discriminating section, and to execute a transaction processing on the basis of stated contents of a medium that has been identified as the transaction medium by the discriminating section. The program relating to the second invention can cause an automatic transaction device, that has a reduced number of structural elements that are exclusively used for the handling of a transaction medium, to operate suitably.

### Advantageous Effects of Invention

In accordance with the present invention, an automatic transaction device having a reduced number of structural elements that are exclusively used for handling a transaction medium, and a program thereof, can be provided.

### BRIEF DESCRIPTION OF DRAWINGS

FIG. 1 is a drawing showing the external structure of an automatic transaction device relating to embodiment 1.

FIG. 2 is a drawing showing the functional structure of the automatic transaction device relating to embodiment 1.

FIG. 3 is a drawing showing the schematic structure of a conveying system of the automatic transaction device relating to embodiment 1.

FIG. 4 is a drawing showing the way of inserting a transaction medium into a media insert port of the automatic transaction device relating to embodiment 1.

FIG. 5 is drawing (1) showing the structure of a transaction medium that is used in embodiment 1.

FIG. 6 is drawing (2) showing the structure of a transaction medium that is used in embodiment 1.

FIG. 7 is drawing (3) showing the structure of a transaction medium that is used in embodiment 1.

FIG. 8 is drawing (4) showing the structure of a transaction medium that is used in embodiment 1.

FIG. 9 is drawing (5) showing the structure of a transaction medium that is used in embodiment 1.

FIG. 10A is flowchart (1) showing operations of the automatic transaction device relating to embodiment 1.

FIG. 10B is flowchart (2) showing operations of the automatic transaction device relating to embodiment 1.

FIG. 11A is drawing (1) showing the structure of a display screen that is used in embodiment 1.

FIG. 11B is drawing (2) showing the structure of a display screen that is used in embodiment 1.

FIG. 11C is drawing (3) showing the structure of a display screen that is used in embodiment 1.

FIG. 11D is drawing (4) showing the structure of a display screen that is used in embodiment 1.

FIG. 11E is drawing (5) showing the structure of a display screen that is used in embodiment 1.

FIG. 12 is a drawing showing the way of inserting a transaction medium into the media insert port of an automatic transaction device relating to embodiment 2.

FIG. 13 is flowchart showing operations of the automatic transaction device relating to embodiment 2.

FIG. 14 is flowchart showing operations of an automatic transaction device relating to embodiment 3.

### DESCRIPTION OF EMBODIMENTS

Embodiments of the present invention (hereinafter called “present embodiments”) are described in detail hereinafter with reference to the drawings. Note that the respective drawings merely illustrate the present invention schematically to the extent that the present invention can be understood sufficiently. Accordingly, the present invention is not limited only to the illustrated examples. Further, in the respective drawings, common structural elements and similar structural elements are denoted by the same reference numerals, and repeat description thereof is omitted.

### Embodiment 1

The present invention provides an automatic transaction device (ATM) that is an automatic transaction device that has a structure that is similar to the external structure of a conventional automatic transaction device but without being provided with structural elements that are exclusively used for handling transaction media (e.g., an insert port exclusively used for the insertion of a transaction medium into the device, a recognizing section exclusively used for recognizing the stated contents of the transaction medium, a conveying section or a conveying path exclusively used for conveying a transaction medium from the insert port to the recognizing section or an accommodating section, and the like), and that automatically executes a transfer transaction processing on the basis of the stated contents of the transaction medium and by simple operation. Here, the “stated contents of the transaction medium” means, for example, barcodes and characters that are printed on the transaction medium, characters that are written-in by hand on the transaction medium, and the like.

<Structure of Automatic Transaction Device>

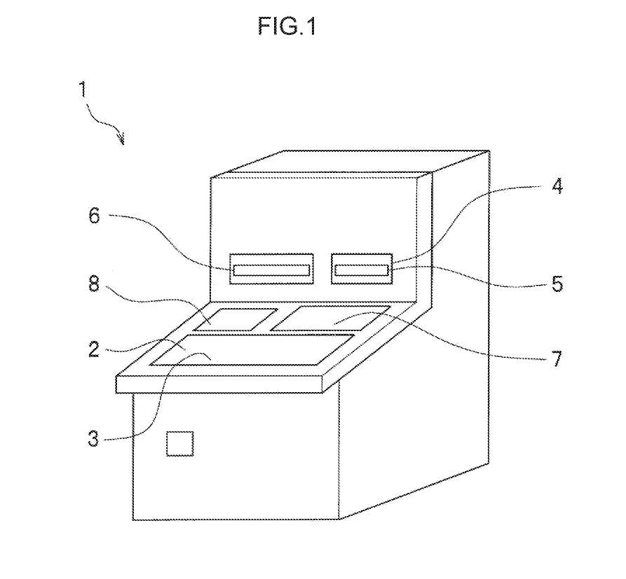

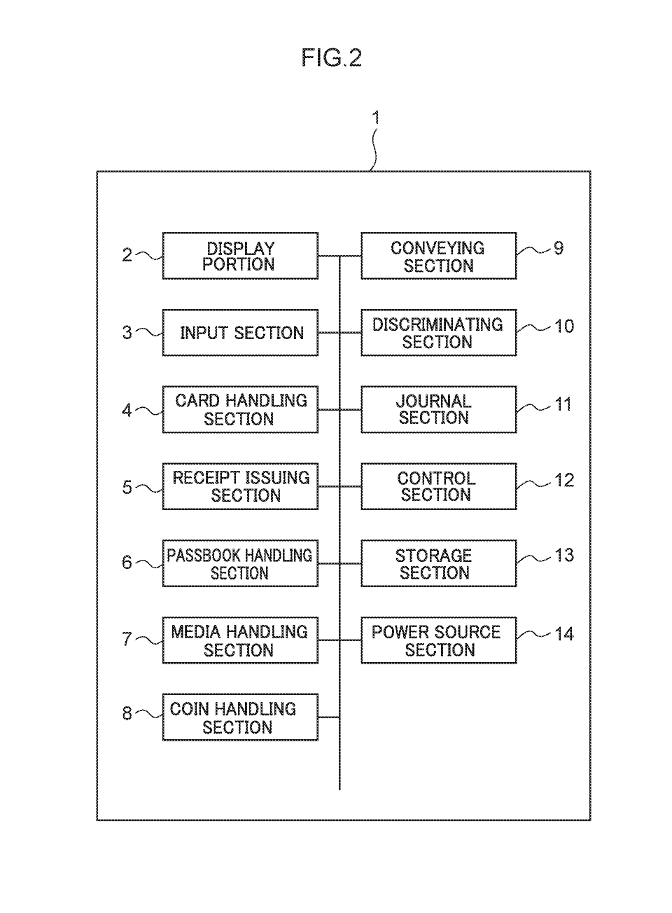

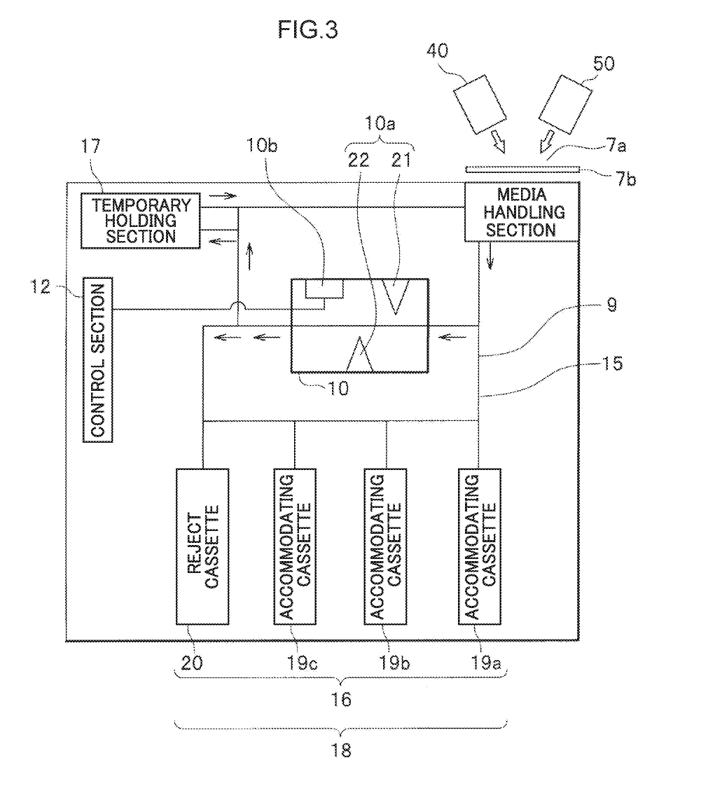

The structure of an automatic transaction device relating to present embodiment 1 is described hereinafter with reference to FIG. 1 through FIG. 3. FIG. 1 is a drawing showing the external structure of the automatic transaction device relating to present embodiment 1. FIG. 2 is a drawing showing the functional structure of the automatic transaction device relating to present embodiment 1. FIG. 3 is a drawing showing the schematic structure of a conveying system of the automatic transaction device relating to present embodiment 1.

An automatic transaction device 1 relating to the present embodiment differs, when compared with a conventional automatic transaction device, with respect to (a) the point that bills and a transaction medium are inserted into a same insert port (media insert port 7a (see FIG. 3) that is described later) and are conveyed on a same conveying path (conveying path 15 (see FIG. 3) that is described later), and (b) the point that the contents of the operations of a conveying section 9 (see FIG. 2 and FIG. 3) that is described later, a discriminating section 10 (see FIG. 2 and FIG. 3) that is described later, and a control section 12 (see FIG. 3 and FIG. 3) that is described later (i.e., the contents of control programs that control the operations of these) are different.

As shown in FIG. 1, the automatic transaction device 1 relating to the present embodiment has, at the front surface side thereof, a display portion 2, an input section 3, a card handling section 4, a receipt issuing section 5, a passbook handling section 6, a media handling section 7 and a coin handling section 8.

The display portion 2 is a structural element that displays various types of information. The display portion 2 is structured by an LCD for example. The input section 3 is a structural element that inputs various types of information. In present embodiment 1, description is given with the input section 3 being structured by a touch panel that is set on the display portion 2.

The card handling section 4 is a structural element that handles card media such as, for example, cash cards and transfer cards and the like. When a card medium is inserted therein, the card handling section 4 reads magnetic information from the magnetic stripe provided on the card medium.

The receipt issuing section 5 is a structural element that issues a receipt in a case in which a transfer transaction processing, that is based on the stated contents of a transaction medium, is executed. Here, “receipt” means a medium on which transaction content information of the transfer transaction processing is stated. The receipt issuing section 5 copies an image picture of the transaction medium (in particular, an image of a customer copy portion 63 (see FIG. 5 through FIG. 9) that is described later) onto a medium for issuing that is readied in advance within the device, and prints the transaction content information and an image of a signature stamp onto this medium for issuing, and thereby creates a receipt. Here, “transaction content information” means information such as the transaction date and time of the transfer transaction processing, the payee, the transferred amount, and the like. Further, the “image of a signature stamp” means an image corresponding to the receipt stamp of the payment receiving agent company (in present embodiment 1, the financial institution or distribution institution that owns the automatic transaction device 1).

The passbook handling section 6 is a structural element that handles passbooks. When a passbook is inserted therein, the passbook handling section 6 reads magnetic information from the magnetic stripe provided on the passbook, and prints the transaction content information in the passbook.

The media handling section 7 is a structural element that handles bills and transaction media. Here, “transaction media” are media that are called, for example, a “transfer form”, a “payment form”, a “check” or the like, and mean media that are used in order to execute transfer (payment) transaction processings of various types of fees for electricity, gas and others to an enterprise, and to execute deposit transaction processings. Note that the media handling section 7 corresponds to a structural element that is generally called a “bill handling section” for example. However, in present embodiment 1, this structural element handles not only bills but transaction media as well, and therefore, this structural element is described by being called the “media handling section 7”. The media handling section 7 has the media insert port 7a (see FIG. 3) into which bills and transaction media are inserted, and, when bills and a transaction medium are inserted into the media insert port 7a, the media handling section 7 takes the bills and transaction medium in into the interior of the device.

The coin handling section 8 is a structural element that handles coins. The coin handling section 8 has a coin insert port (not illustrated) into which coins are inserted. When coins are inserted into the coin insert port, the coin handling section 8 takes the coins in into the interior of the device.

As shown in FIG. 2, the automatic transaction device 1 has, in addition to these structural elements and at the interior thereof, the conveying section 9, the discriminating section 10, a journal section 11, the control section 12, a storage section 13, and a power source section 14.

The conveying section 9 is a structural element that conveys various types of media (e.g., bills and transaction media, coins, card media, passbooks, and the like) to predetermined places. The conveying section 9 is provided along the conveying path 15 (see FIG. 3). The discriminating section 10 is a structural element that recognizes the denomination of a bill 40 and the stated contents of a transaction medium 50.

The journal section 11 is a structural element that records a journal that shows transaction content information.

The control section 12 is a structural element that controls the respective structural elements. The control section 12 is structured as a computer in which a general-purpose OS, such as Windows® or the like for example, is installed. The control section 12 executes a transaction processing on the basis of the stated contents of the transaction medium 50 that have been recognized by the discriminating section 10.

The storage section 13 is a structural element that stores various types of information and control programs.

The power source section 14 is a structural element that supplies the needed power supply to the respective structural elements.

As shown in FIG. 3, the automatic transaction device 1 has, at the media handling section 7, the media insert port 7a and a shutter 7b.

The media insert port 7a is an insert port into which the bills 40 and the transaction medium 50 are inserted.

The shutter 7b is a door that selectively opens or closes the media insert port 7a.

The automatic transaction device 1 has, at the interior thereof, the conveying path 15, a bill accommodating section 16, a temporary holding section 17 and a transaction media accommodating section 18.

The conveying path 15 is a path on which the bills 40 and the transaction media 50 are conveyed.

The bill accommodating section 16 is a structural element in which the bills 40 are accommodated. The bill accommodating section 16 is structured by plural accommodating cassettes (in the example shown in FIG. 3, three accommodating cassettes 19a, 19b, 19c) that accommodate the bills 40 that can be recycled, and a reject cassette 20 that accommodates the bills 40 that cannot be recycled. The denominations of the bills 40 that are accommodated at the interiors of the respective accommodating cassettes 19a, 19b, 19c can be set arbitrarily. The respective accommodating cassettes 19a, 19b, 19c and the reject cassette 20 are structured as cassettes that are freely set in and removed from the automatic transaction device 1. The cassettes that are set in the automatic transaction device 1 can be replaced with other cassettes.

The temporary holding section 17 is a structural element that temporarily accommodates the bills 40, whose denominations have been confirmed by recognition at the discriminating section 10, and the transaction medium 50. The temporary holding section 17 is provided at the downstream side of the discriminating section 10.

The transaction media accommodating section 18 is a structural element in which the transaction media 50 are accommodated. The automatic transaction device 1 uses an arbitrary cassette among the plural accommodating cassettes (in the example shown in FIG. 3, the three accommodating cassettes 19a, 19b, 19c) and the reject cassette 20 that structure the bill accommodating section 16, as the transaction media accommodating section 18.

At the automatic transaction device 1, when media (the bills 40 and the transaction medium 50) are inserted by a remitter (an operator) into the media insert port 7a, the media handling section 7 takes the media in into the interior of the device, and the conveying section 9 conveys the media from the media handling section 7 toward predetermined places. At this time, the automatic transaction device 1 causes the media to pass through the discriminating section 10. Hereinafter, the medium that is conveyed by the conveying section 9 is called the “conveyed medium”.

In present embodiment 1, the discriminating section 10 is controlled by a control program that is stored in advance in an unillustrated memory of the discriminating section 10 and is structured as follows. For example, this control program is structured to cause a computing section (computer) of the discriminating section 10 to, on the basis of an image of the conveyed medium that is conveyed on the conveying path 15, identify whether the conveyed medium is the bill 40 or is the transaction medium 50, and, when the conveyed medium is identified to be the bill 40, recognize the denomination thereof, and, on the other hand, when the conveyed medium is identified to be the transaction medium 50, recognize the stated contents thereof. Accordingly, at the time when the conveyed media (the bills 40 and the transaction medium 50) pass-through the discriminating section 10, the discriminating section 10 recognizes the denominations of the bills 40 and the stated contents of the transaction medium 50.

The discriminating section 10 is equipped with an image acquiring section 10a and an image recognizing section 10b.

The image acquiring section 10a is a structural element that acquires (images) the image information of the both sides of the conveyed media (the bills 40 and the transaction medium 50). The image acquiring section 10a is structured by reflection sensors 21, 22 that are provided above and below the conveying path 15 respectively, and various types of sensors that are not illustrated. The image acquiring section 10a acquires (images) the image information of the both sides of the conveyed media (the bills 40 and the transaction medium 50) by the reflection sensors 21, 22, and outputs the acquired image information to the image recognizing section 10b.

The image recognizing section 10b is a functional means that identifies whether the conveyed medium is the bill 40 or is the transaction medium 50, and, when the conveyed medium is identified to be the bill 40, recognizes the denomination thereof, and, on the other hand, when the conveyed medium is identified to be the transaction medium 50, recognizes the stated contents thereof. The image recognizing section 10b has an unillustrated memory and computing section.

The image recognizing section 10b stores, in the memory, the image information of the both sides of the conveyed media (the bills 40 and the transaction medium 50) that was acquired by the image acquiring section 10a. Then, at the image recognizing section 10b, the computing section reads-out from the memory the image information of the both sides of the conveyed media, and executes optical character recognition processing (OCR processing) on the read-out image information of the both sides of the conveyed media. Next, on the basis of the results of the optical character recognition, the image recognizing section 10b identifies whether the conveyed medium is the bill 40 or is the transaction medium 50, and further, when the conveyed medium is identified to be the bill 40, recognizes the denomination thereof, and, on the other hand, when the conveyed medium is identified to be the transaction medium 50, recognizes the stated contents thereof. Thereafter, the image recognizing section 10b outputs the results of recognition of the denominations of the bills 40 and the stated contents of the transaction medium 50 to the control section 12. The image recognizing section 10b has a CPU, a RAM, and a ROM (a storage medium) in which is stored a recognition program that acquires images from the image acquiring section 10a and recognizes the acquired images.

In accordance with the results of recognition of the image recognizing section 10b (i.e., the denomination of the bill 40 or the stated contents of the transaction medium 50), the control section 12 determines the conveying destination of the conveyed medium (i.e., the bill 40 or the transaction medium 50). For example, the control section 12 decides on the temporary holding section 17 as the conveying destination of the transaction medium 50 and of the bill 40 whose denomination was confirmed by the recognition of the first time by the image recognizing section 10b, and, on the other hand, decides on the media insert port 7a as the conveying destination of the bill 40 whose denomination was not confirmed by the recognition of the first time by the image recognizing section 10b. Further, for example, the control section 12 decides on the cassette of the corresponding denomination, among the accommodating cassettes 19a˜19c, as the conveying destination of the conveyed medium that was recognized as the bill 40, that can be recycled, by the recognition of the second time or a time thereafter by the image recognizing section 10b on a medium that was accommodated in the temporary holding section 17, and decides on the reject cassette 20 as the conveying destination of a conveyed medium that was recognized as the bill 40 that cannot be recycled, and decides on the cassette, that was set as the transaction media accommodating section 18 among the accommodating cassettes 19a˜19c and the reject cassette 20, as the conveying destination of the conveyed medium that was recognized as the transaction medium 50.

<Way of Inserting Transaction Medium into Media Insert Port>

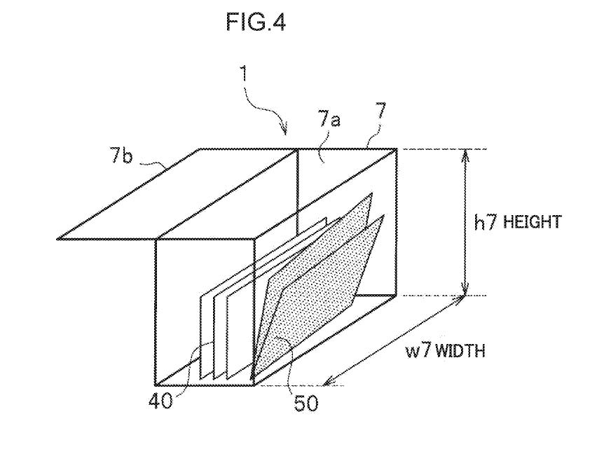

The way of inserting the transaction medium 50 into the media insert port 7a is described hereinafter with reference to FIG. 4 through FIG. 9. FIG. 4 is a drawing showing the way of inserting, into the media insert port 7a, the transaction medium 50 of the automatic transaction device 1 relating to present embodiment 1. FIG. 5 through FIG. 9 are drawings respectively showing the structure of the transaction medium 50 that is used in present embodiment 1.

As shown in FIG. 4, the media insert port 7a is a structure whose interior is formed in the shape of a box that is hollow, and the upper portion thereof is open and closed by the shutter 7b.

The dimensions of width w7 and height h7 of the interior of the media insert port 7a are set to be a size (e.g., a size in which the width w7 is around 185 mm and the height h7 is around 120 mm) that is one size larger than that of the bill 40 of the maximum size that is in circulation. In contrast, the dimension of the width (or the height) of the transaction medium 50 is prescribed to be a size that is larger than dimension of the width w7 (or the height h7) of the interior of the media insert port 7a. Accordingly, the remitter must fold the transaction medium 50 in order to insert the transaction medium 50 into the media insert port 7a.

In the example shown in FIG. 4, the transaction medium 50 is folded in the length direction, and is inserted in the media insert port 7a together with the bills 40. However, as shown in FIG. 5 through FIG. 9, plural types of the transaction medium 50 exist, and the way of folding differs in accordance with the type.

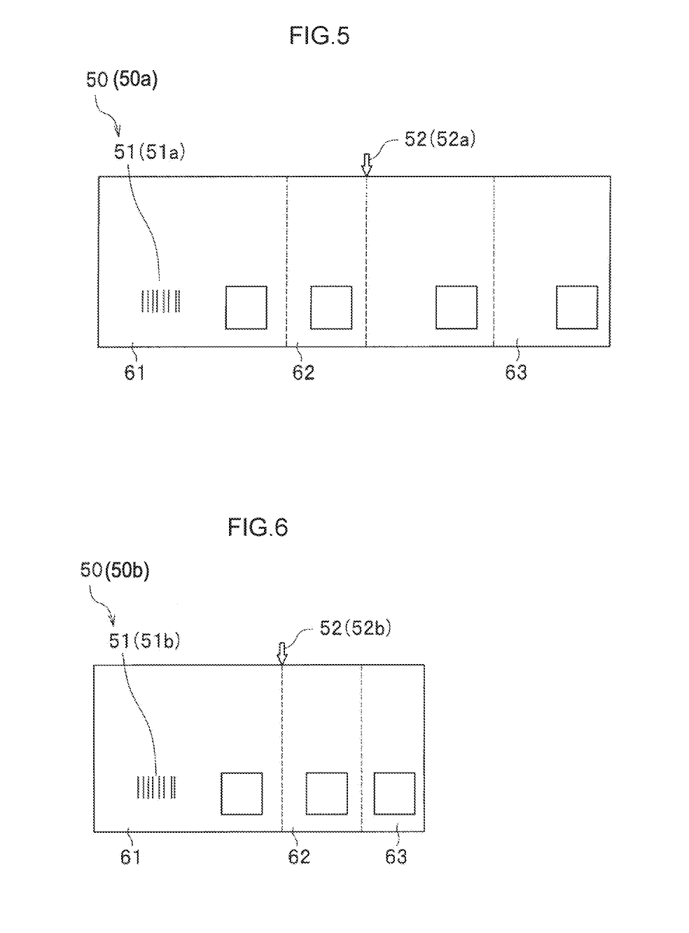

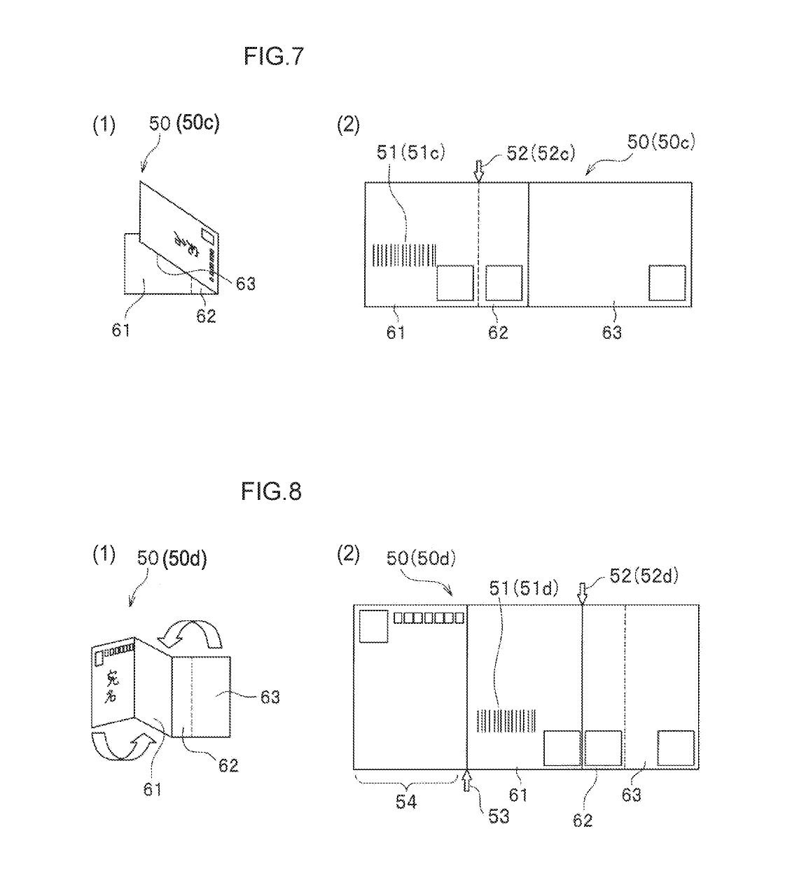

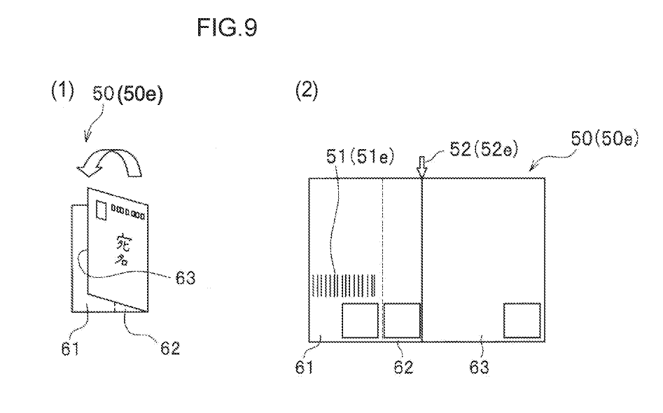

FIG. 5 shows the structure of the four-continuous-panel enclosure-type transaction medium 50. Further, FIG. 6 shows the structure of the three-continuous-panel enclosure-type transaction medium 50. Further, FIG. 7 shows the structure of the three-continuous-panel both-side-printed mailing card type transaction medium 50. Further, FIG. 8 shows the structure of the Z-fold mailing card type transaction medium 50. Further, FIG. 9 shows the structure of the single-fold mailing card type transaction medium 50.

Hereinafter, when differentiating the respective transaction media 50 that are shown in FIG. 5 through FIG. 9, the four-continuous-panel enclosure-type transaction medium 50 shown in FIG. 5 is called “transaction medium 50a”, the three-continuous-panel enclosure-type transaction medium 50 shown in FIG. 6 is called “transaction medium 50b”, the three-continuous-panel both-side-printed mailing card type transaction medium 50 shown in FIG. 7 is called “transaction medium 50c”, the Z-fold mailing card type transaction medium 50 shown in FIG. 8 is called “transaction medium 50d”, and the single-fold mailing card type transaction medium 50 shown in FIG. 9 is called “transaction medium 50e”.

Note that FIG. 5 shows the structure of the surface, at the side at which a barcode 51 is provided, of the transaction medium 50a (hereinafter called “barcode surface”). Further, FIG. 6 shows the structure of the barcode surface of the transaction medium 50b. Further, FIG. 7(1) shows the way of opening the transaction medium 50c, and FIG. 7(2) shows the structure of the barcode surface of the transaction medium 50c. Further, FIG. 8(1) shows the way of opening the transaction medium 50d, and FIG. 8(2) shows the structure of the barcode surface of the transaction medium 50d. Further, FIG. 9(1) shows the way of opening the transaction medium 50e, and FIG. 9(2) shows the structure of the barcode surface of the transaction medium 50e.

The transaction media 50a, 50b shown in FIG. 5 and FIG. 6 are respectively, for example, sealed within an envelope and sent from an enterprise to the remitter (the operator). Further, the transaction media 50c, 50d, 50e shown in FIG. 7 through FIG. 9 are respectively, for example, sent as a mailing card from an enterprise to the remitter (the operator).

As shown in FIG. 5 through FIG. 9, the transaction medium 50 is structured so as to be able to be separated into a main copy portion 61, a store copy portion 62, and the customer copy portion 63. The main copy portion 61 is the region that is archived by the payment receiving agent company (in present embodiment 1, the financial institution or distribution institution that owns the automatic transaction device 1). The store copy portion 62 is the region that is archived by the handling store. The customer copy portion 63 is the region that is archived by the remitter (the operator). The main copy portion 61, the store copy portion 62 and the customer copy portion 63 respectively are provided with a signature stamp area in which the receipt stamp of the payment receiving agent company is stamped.

However, in present embodiment 1, the automatic transaction device 1 accommodates the transaction medium 50 as is in its folded state in the transaction media accommodating section 18 (see FIG. 3) without separating the respective portions of the transaction medium 50, and further, without stamping the receipt stamp in the signature stamp areas. Further, the automatic transaction device 1 creates a receipt at the receipt issuing section 5 (see FIG. 1 and FIG. 2), and issues the receipt to the remitter (the operator) instead of the customer copy portion 63. Note that the transaction media 50 that are accommodated in the transaction media accommodating section 18 are collected from the automatic transaction device 1 by the payment receiving agent company, and are archived by the payment receiving agent company.

The barcode 51 (51a˜51e) is printed on the main copy portion 61 at the respective transaction media 50a˜50e that are shown in FIG. 5 through FIG. 9. The barcode 51 expresses, for example, information that specifies the remitter, and information such as the name of the payee, the account number of the payee, the amount to be transferred (the invoiced amount), and the like.

Plural perforations for separating the main copy portion 61, the store copy portion 62, the customer copy portion 63 and the like are provided in advance at the respective transaction media 50a˜50e that are shown in FIG. 5 through FIG. 9. In present embodiment 1, any one perforation among the plural perforations is used as a fold place 52 for folding the transaction medium 50.

In the example shown in FIG. 5, the transaction medium 50a is structured such that the main copy portion 61 is disposed at the left end, the store copy portion 62 is disposed so as to be able to be separated at the left side and the right side of the substantially central portion, and the customer copy portion 63 is disposed at the right end. At the transaction medium 50a, the perforation that is provided between the left side and the right side of the store copy portion 62 is used as fold place 52a.

As shown in FIG. 6, the transaction medium 50b is structured such that the main copy portion 61 is disposed at the left end, the store copy portion 62 is disposed substantially in the center, and the customer copy portion 63 is disposed at the right end. At the transaction medium 50b, the perforation that is provided between the main copy portion 61 and the store copy portion 62 is used as fold place 52b.

As shown in FIG. 7(2), the transaction medium 50c is structured such that the main copy portion 61 is disposed at the left end, the store copy portion 62 is disposed at the substantial center, and the customer copy portion 63 is disposed at the right end. At the transaction medium 50c, the perforation that is provided between the main copy portion 61 and the store copy portion 62 is used as fold place 52c.

As shown in FIG. 8(2), the transaction medium 50d is structured such that a tear-off portion 54 is disposed at the left end, the main copy portion 61 is disposed substantially in the center, the store copy portion 62 is disposed at a position that is toward the right side from the substantial center, and the customer copy portion 63 is disposed at the right end. Here, the “tear-off portion 54” means the portion that is torn-off by the remitter (the operator). At the transaction medium 50d, the perforation that is provided between the tear-off portion 54 and the main copy portion 61 is a severing place 53, and the transaction medium 50d is separated by the remitter along the severing place 53 into the tear-off portion 54 and the portion other than that (i.e., the portion of the main copy portion 61, the store copy portion 62 and the customer copy portion 63). At the transaction medium 50d, the perforation that is provided between the main copy portion 61 and the store copy portion 62 is used as fold place 52d.

As shown in FIG. 9(2), the transaction medium 50e is structured such that the main copy portion 61 is disposed at the left end, the store copy portion 62 is disposed at a position that is toward the left side from the substantial center, and the customer copy portion 63 is disposed so as to span from the substantial center to the right end. At the transaction medium 50e, the perforation that is provided between the store copy portion 62 and the customer copy portion 63 is used as fold place 52e.

<Operation of Automatic Transaction Device>

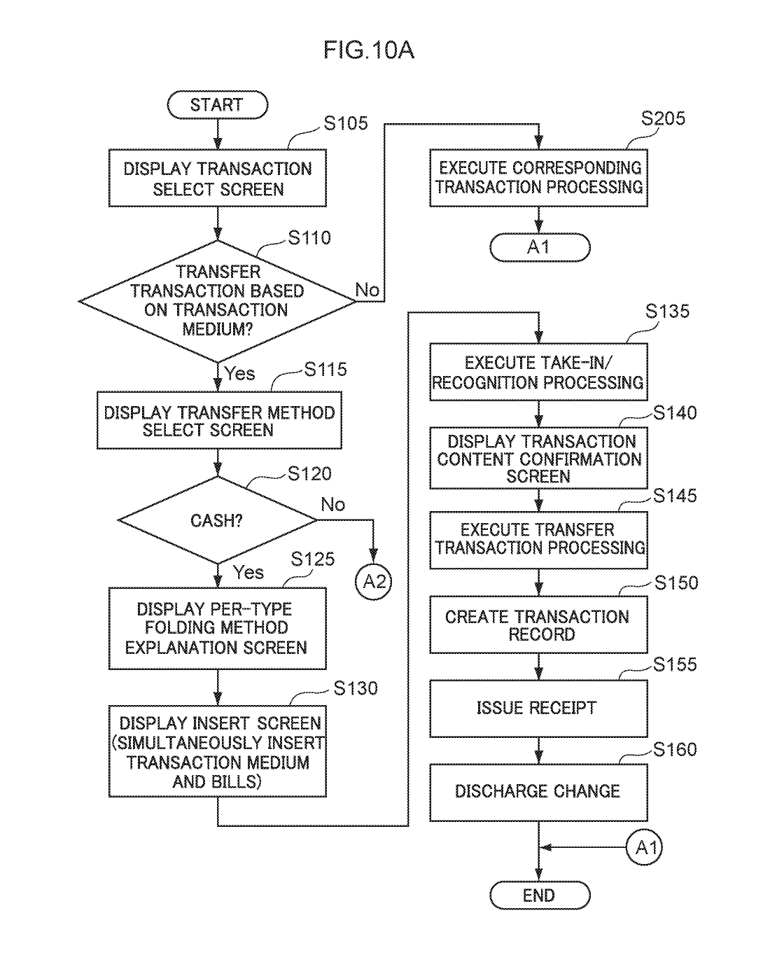

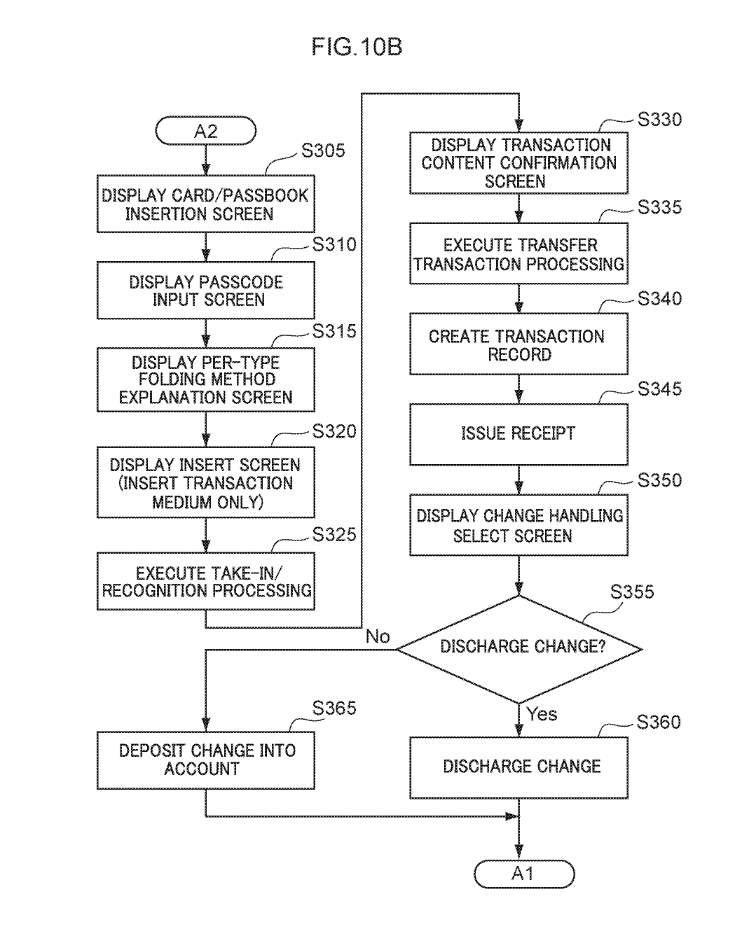

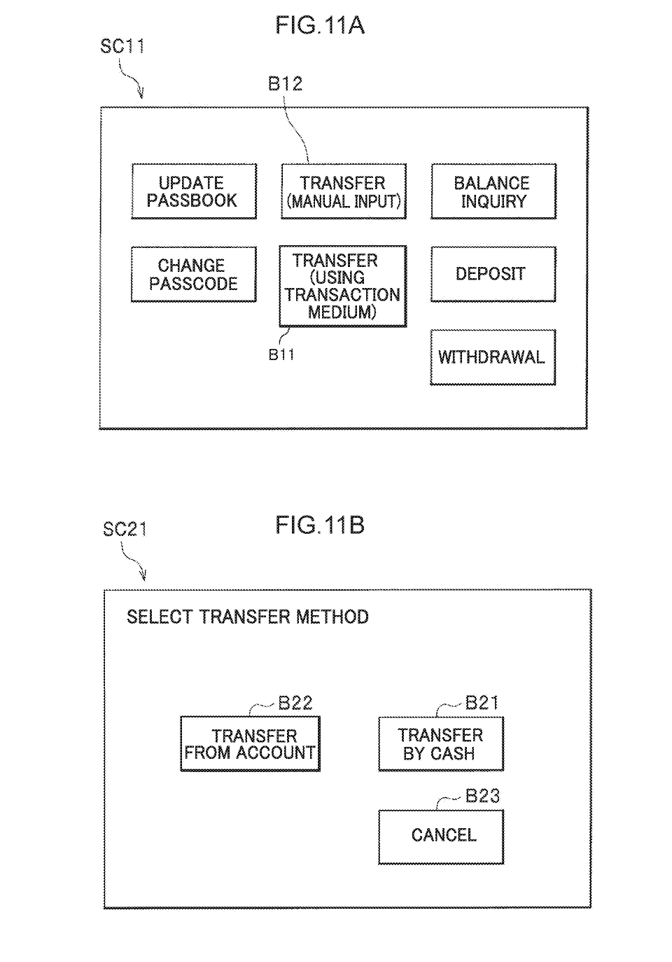

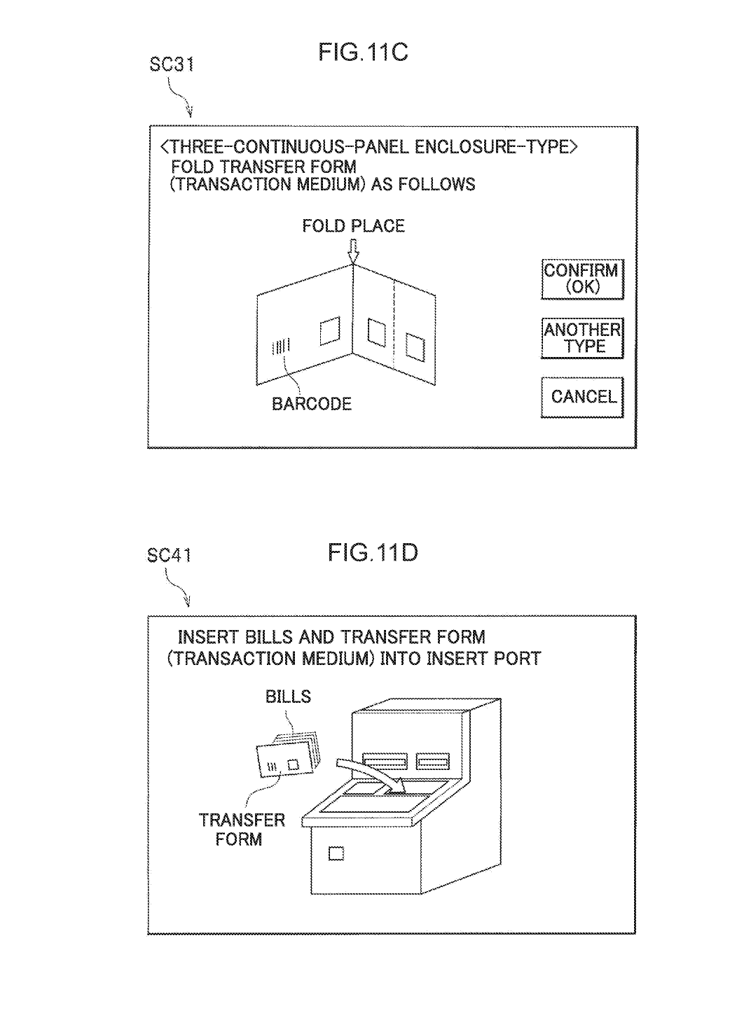

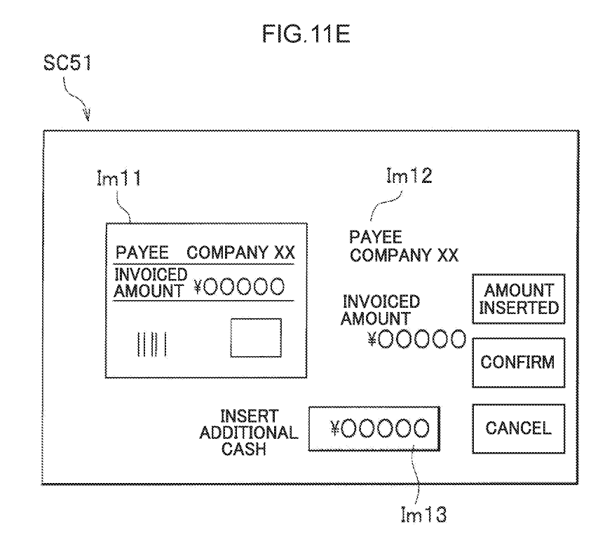

Operation of the automatic transaction device 1 is described hereinafter with reference to FIG. 10A and FIG. 10B, and FIG. 11A through FIG. 11E. Here, description is given while assuming a case in which the remitter operates the automatic transaction device 1, and causes the automatic transaction device 1 to execute a transfer transaction processing. FIG. 10A and FIG. 10B respectively are flowcharts showing operations of the automatic transaction device 1 relating to present embodiment 1. FIG. 11A through FIG. 11E respectively are drawings showing the structures of display screens that are used in present embodiment 1.

Note that the automatic transaction device 1 of present embodiment 1 operates on the basis of time that is measured by an unillustrated timer. Further, the series of operations of the automatic transaction device 1 of present embodiment 1 is prescribed by a control program, that is stored in advance in the storage section 13 so as to be freely read-out therefrom, and is controlled by the control section 12. Detailed description of these points is omitted hereinafter because the information processing is a conventional means.

When a remitter (an operator) approaches, the control section 12 of the automatic transaction device 1 senses the approach of the remitter on the basis of the value of a signal that is outputted from an unillustrated proximity sensor. Thereupon, the control section 12 causes the display portion 2 to display, for example, transaction select screen SC11, that is shown in FIG. 11A, as the initial screen (S105).

The transaction select screen SC11 is a screen in which candidates of plural types of transaction processings that can be selected are displayed in a list. In the example shown in FIG. 11A, the transaction select screen SC11 is a structure that includes button B11 and button B12 as buttons for instructing execution of transfer transaction processings. The button B11 is a button for instructing execution of a transfer transaction processing that is based on the stated contents of the transaction medium 50. On the other hand, the button B12 is a button for instructing execution of a transfer transaction processing that is based on information inputted by manual input.

When the transaction select screen SC11 is displayed on the display portion 2, the remitter selects and presses a button that instructs execution of an arbitrary transaction processing from the transaction select screen SC11. Thereupon, the input section 3 that is structured as a touch panel outputs, to the control section 12, a signal of the value that is associated with the position of the button that has been pressed. Due thereto, the control section 12 senses the pressing of a button (the same holds hereinafter).

When the control section 12 senses the pressing of a button, the control section 12 judges whether or not the pressed button is a button that instructs the execution of a transfer transaction processing that is based on the transaction medium 50 (i.e., whether or not the pressed button is the button B11) (S110).

In the judgment of S110, in a case in which the pressed button is not the button that instructs execution of a transfer transaction processing that is based on the transaction medium 50 (i.e., the pressed button is a button other than the button B11, the case of “No”), the control section 12 executes the transaction processing that corresponds to the pressed button (S205). Thereafter, processing ends.

On the other hand, in the judgment of S110, in a case in which the pressed button is the button that instructs execution of a transfer transaction processing that is based on the transaction medium 50 (i.e., the pressed button is the button B11, the case of “Yes”), the control section 12 causes the display portion 2 to display transfer method select screen SC21 that is shown in FIG. 11B for example (S115).

The transfer method select screen SC21 is a screen for causing the remitter to select whether to execute the transfer transaction processing by cash, or to execute the transfer transaction processing by moving cash information between two accounts. In the example shown in FIG. 11B, the transfer method select screen SC21 is structured to include buttons B21˜B23. Button B21 is a button for instructing execution of the transfer transaction processing by cash. Button B22 is a button for instructing execution of the transfer transaction processing by moving cash information between two accounts. Button B23 is a cancel button that instructs cancelling of the transfer transaction processing.

When the transfer method select screen SC21 is displayed on the display portion 2, the remitter selects and presses an arbitrary button in accordance with the instructions of the guidance that is displayed on the screen. Here, explanation is given of the remitter pressing either one of the button B21 and the button B22.

When the control section 12 senses the pressing of a button, the control section 12 judges whether or not the button that was pressed is the button B21 for instructing execution of the transfer transaction processing by cash (S120).

In the judgment of S120, in a case in which the pressed button is not the button B21 that instructs execution of the transfer transaction processing by cash (here, the pressed button is the button B22 for instructing execution of the transfer transaction processing by moving cash information between two accounts, the case of “No”), the processing moves via reference numeral “A2” to S305 shown in FIG. 10B.

On the other hand, in the judgment of S120, in a case in which the pressed button is the button B21 that instructs execution of the transfer transaction processing by cash (the case of “Yes”), the control section 12 causes the display portion 2 to display, for example, a per-type folding method explanation screen SC31 that is shown in FIG. 11C (S125).

The per-type folding method explanation screen SC31 is a screen for explaining the way of folding the transaction medium 50, per type of the transaction medium 50. The per-type folding method explanation screen SC31 induces the remitter to fold the transaction medium 50 by showing the way of folding the transaction medium 50 per type. In the example shown in 11C, the per-type folding method explanation screen SC31 is structured to give notice of the type of the transaction medium 50, and to include guidance information that instructs folding of the transaction medium 50, and an image showing the way of folding the transaction medium 50, and the like.

The per-type folding method explanation screen SC31 may be displayed when, after a selection screen that displays in a list the transaction media 50a˜50e of the respective types that can be selected, the transaction medium 50 of the corresponding type is selected on that selection screen. Or, at the per-type folding method explanation screen SC31, screens that correspond to the transaction media 50a˜50e of the respective types may be displayed cyclically for a uniform time each. Preferably, it is good for the per-type folding method explanation screen SC31 to be structured to include a cancel button for cancelling the transfer transaction processing in a case in which a corresponding type does not exist.

The image that shows the way of folding the transaction medium 50 is structured so that the transaction medium 50 is folded such that the barcode surface of the main copy portion 61 (see FIG. 5 through FIG. 9) is certainly disposed at the outer side. For example, in a case in which the transaction medium 50 is the four-continuous-panel enclosure-type transaction medium 50a (see FIG. 5), the image that shows the way of folding the transaction medium 50 is structured so that the transaction medium 50 is folded into the shape of a mountain at the fold place 52a such that the barcode surface of the main copy portion 61 is disposed at the outer side. Due thereto, at the time when the automatic transaction device 1 passes the transaction medium 50 through the discriminating section 10 (see FIG. 3), the automatic transaction device 1 can always cause the image acquiring section 10a (see FIG. 3) to acquire (image) the image of the barcode surface of the main copy portion 61.

Further, the per-type folding method explanation screen SC31 is structured to include an “another type” button, a “cancel button”, and a “confirm (OK)” button. The “another type” button is a button for causing a folding method explanation screen of a different type of the transaction medium 50 to be displayed. The “cancel” button is a button for instructing cancelling of the transfer transaction processing. The “confirm (OK)” button is a button for instructing movement to the next step. The screen can be switched due to the remitter pressing the “another type” button or the “confirm (OK)” button.

Here, description is given of the transaction medium 50 being folded in accordance with the instructions of the guidance displayed on the per-type folding method explanation screen SC31, and thereafter, the “confirm (OK)” button being pressed.

When the control section 12 senses pressing of the “confirm (OK)” button, the control section 12 causes the display portion 2 to display insert screen SC41 that is shown in FIG. 11D for example (S130). Then, the control section 12 causes the media handling section 7 to open the shutter 7b, and causes a lamp (not illustrated) that is provided in a vicinity of (or at the interior of) the media insert port 7a to flash, and urges the remitter to insert the bills 40 and the transaction medium 50.

The insert screen SC41 is a screen that explains the way of inserting the transaction medium 50 into the media insert port 7a. In present embodiment 1, the insert screen SC41 has the contents that the bills 40 and the transaction medium 50 are to be inserted in a superposed manner and simultaneously (at the same time). Note that, in present embodiment 1, the automatic transaction device 1 is structured such that the conveying section 9 individually separates the bills 40 and the transaction medium 50 that have been inserted simultaneously (at the same time), and conveys them successively.

Preferably, it is good that that the insert screen SC41 is structured such that the barcode surface of the main copy portion 61 (see FIG. 5 through FIG. 9) of the transaction medium 50 always faces in a given direction (for example, in the example shown in FIG. 11D, the direction facing the remitter). Due thereto, at the time when the automatic transaction device 1 passes the transaction medium 50 through the discriminating section 10 (see FIG. 3), the barcode surface of the main copy portion 61 can always be made to face in the direction of either one of the reflection sensors 21, 22 (see FIG. 3). Therefore, the automatic transaction device 1 can improve the processing speed at the time of recognizing the stated contents of the transaction medium 50.

When the insert screen SC41 is displayed on the display portion 2, the remitter inserts the bills 40 and the transaction medium 50 in the media insert port 7a in accordance with the guidance displayed on the screen. FIG. 4 shows the state of the bills 40 and the transaction medium 50 that have been inserted into the media insert port 7a. Hereinafter, when collectively referring to the bills 40 and the transaction medium 50 that have been inserted in the media insert port 7a, they are simply called the “media”.

Note that the insert screen SC41 may be structured to include a coin insert button (not illustrated) for making the insertion of coins possible. In this case, when the remitter presses the coin insert button, the automatic transaction device 1 opens a shutter (not illustrated) that is provided at a coin insert port (not illustrated) of the coin handling section 8, and causes the remitter to insert coins. Due thereto, the remitter can insert cash that includes not only the bills 40, but also coins, into the automatic transaction device 1. Detailed description of the insertion of coins is omitted here.

When the media (here, the bills 40 and the transaction medium 50) are inserted in the media insert port 7a, the control section 12 causes the media handling section 7 to take the media into the device while separating them one-by-one, and causes the discriminating section 10 to execute recognition processing on each of the media (S135).

At this time, first, the control section 12 causes the media handling section 7 to close the shutter 7b, and next, causes the media handling section 7 to send the bills 40 and the transaction medium 50 out to the conveying path 15 as conveyed media while separating them one-by-one.

Then, the control section 12 causes the conveying section 9 to convey the respective conveyed media toward the discriminating section 10, and to pass the respective conveyed media through the discriminating section 10, and causes the discriminating section 10 to identify whether each of the conveyed media are the bill 40 or are the transaction medium 50, and further, causes the discriminating section 10 to recognize the denomination when a conveyed medium is identified as being the bill 40.

Thereafter, the control section 12 causes the conveying section 9 to convey the bills 40, whose denominations have been confirmed in the recognition at the discriminating section 10, and the transaction medium 50 to the temporary holding section 17 and accommodate the media therein, and, on the other hand, returns the bill 40, whose denomination was not confirmed in the recognition at the discriminating section 10, to the media insert port 7a (the same holds hereinafter).

At this time, each time each of the conveyed media passes-through the discriminating section 10, the image acquiring section 10a of the discriminating section 10 acquires (images) image information of the both sides of the conveyed medium by the reflection sensors 21, 22 (here, the image information of the surface at the side that faces the reflection sensor 21, and the image information of the surface at the side that faces the reflection sensor 22), and outputs the acquired image information to the image recognizing section 10b. Further, the image acquiring section 10a of the discriminating section 10 acquires thickness information and magnetic information and the like of each of the conveyed media by various types of sensors that are not illustrated, and outputs the acquired thickness information and magnetic information and the like to the image recognizing section 10b.

On the basis of the image information of the both sides and the thickness information and the like of each of the conveyed media, the image recognizing section 10b discriminates whether the conveyed medium that has passed-through the discriminating section 10 is the bill 40 or is the transaction medium 50. For example, at this time, the image recognizing section 10b discriminates whether or not the conveyed medium is the transaction medium 50 in accordance with the absence/presence of characteristics that are unique to the transaction medium 50, such as the barcode 51 and the like.

Then, in the case in which the conveyed medium is the bill 40, the image recognizing section 10b executes denomination discrimination and authenticity discrimination of the bill 40 on the basis of the image information and the thickness information, the magnetic information and the like, and recognizes the denomination of the bill 40.

On the other hand, in the case in which the conveyed medium is the transaction medium 50, the image recognizing section 10b recognizes the stated contents of the transaction medium 50 (e.g., the account of the payee and the amount stated on the transaction medium 50 and the like) on the basis of the image information. Accordingly, the processing of S135 is processing that specifies the payee and the amount stated on the transaction medium 50, on the basis of the stated contents of the transaction medium 50. Here, “account of the payee” means the account that is the destination of movement of cash information.

Each time the image recognizing section 10b recognizes each of the conveyed media, the image recognizing section 10b outputs the results of recognition of the conveyed medium to the control section 12. The control section 12 drives the conveying section 9, and causes the conveying section 9 to convey the bills 40, whose denominations have been confirmed by the recognition at the discriminating section 10, and the transaction medium 50 to the temporary holding section 17 and to temporarily accommodate them therein, and computes the total amount of the respective bills 40 that are accommodated within the temporary holding section 17. Further, the control section 12 drives the conveying section 9, and causes the conveying section 9 to return the bill 40, whose denomination was not confirmed by the recognition at the discriminating section 10, to the media insert port 7a. Note that, in a case in which coins are inserted into the device by the remitter, the control section 12 computes the total amount of the cash that has been inserted by the remitter, including the coins and the bills 40. Hereinafter, the total amount of cash that has been inserted by the remitter, including the coins and the bills 40, is called the “inserted amount”.

By the way, extremely fine lines (e.g., lines of a line width of only about 0.16 mm) are included in the barcode 51 of the transaction medium 50. In order to recognize such a barcode, the automatic transaction device 1 must acquire the image information of the barcode 51 at a high resolution of around 400 DPI (dots per inch) for example, and recognize the barcode 51 on the basis of the acquired information of the image that is high resolution (hereinafter simply called “high-resolution image”). To this end, the automatic transaction device 1 must acquire the high-resolution image information of the transaction medium 50 at the image acquiring section 10a while conveying the transaction medium 50 at a low speed. However, it is desirable to increase the processing speed of the automatic transaction device 1. Therefore, the automatic transaction device 1 must convey a large number of media at a high speed (a standard speed), and it is difficult for the automatic transaction device 1 to convey only the transaction medium 50 at a low speed.

Thus, in present embodiment 1, the automatic transaction device 1 is equipped with a function in which the image acquiring section 10a switches the resolution between a standard resolution (e.g., e.g., a resolution of 400 DPI or less) and a high resolution that is higher quality than this standard resolution (e.g., e.g., a resolution of greater than or equal to 400 DPI), and is structured so as to execute the following operations in S135.

The operations of S135 are described in detail hereinafter. In S135, at the automatic transaction device 1, first, the image acquiring section 10a of the discriminating section 10 acquires the information of images of the standard resolution (hereinafter called “standard-resolution images”) of the both sides of the respective media, while the conveying section 9 conveys the respective media, that were inserted in the media insert port 7a, at a high speed (a standard speed) that was set in advance. At this time, the image acquiring section 10a acquires standard-resolution image information of the bills 40 and standard-resolution image information of the transaction medium 50.

Next, at the automatic transaction device 1, the image recognizing section 10b of the discriminating section 10 recognizes the denominations of the bills 40. At this time, the image recognizing section 10b recognizes the layouts of the respective media on the basis of the standard-resolution image information of the respective media, and, by judging whether or not the standard-resolution image information of the respective media have characteristics that are unique to the transaction medium 50 such as the barcode 51 or the like, judges whether or not each of the media is the bill 40 or is the transaction medium 50. Then, in a case in which a medium is the bill 40, the image recognizing section 10b executes denomination discrimination and authenticity discrimination of the bill 40, and recognizes the denomination of the bill 40.

Next, at the automatic transaction device 1, the conveying section 9 conveys the bills 40, whose denominations have been confirmed in the recognition at the discriminating section 10, and the transaction medium 50 to the temporary holding section 17 and accommodates them therein, and returns the bill 40, whose denomination was not confirmed in the recognition at the discriminating section 10, to the media insert port 7a.

At this time, the control section 12 computes the total amount of the bills 40 whose denominations were confirmed and that are accommodated in the temporary holding section 17. Further, at this time, the control section 12 manages which ordinal number of the media, among the respective media that are accommodated in the temporary holding section 17, is the medium that was recognized as being the transaction medium 50 (hereinafter simply called “transaction medium 50” upon occasion). Further, at this time, the automatic transaction device 1 accommodates, in the media insert port 7a and separately from one another, the media that have not yet been conveyed (the media that remain inserted) and the media that have been returned.

The automatic transaction device 1 repeats similar operations until media that have not yet been conveyed disappear from the interior of the media insert port 7a. Then, when media that have not yet been conveyed disappear from the interior of the media insert port 7a, if there is a medium that has been returned to the media insert port 7a, the automatic transaction device 1 opens the shutter 7b, and returns the medium that has been returned to the media insert port 7a to the remitter, and, in its place, receives the additional insertion of a new medium (e.g., the bill 40) into the media insert port 7a. Thereafter, the automatic transaction device 1 repeats similar operations until media that have not yet been conveyed disappear from the interior of the media insert port 7a.

Further, when the media that have not yet been conveyed disappear from the interior of the media insert port 7a, the automatic transaction device 1 adjusts the order of the media such that the transaction medium 50 is conveyed first from the temporary holding section 17 to the discriminating section 10. In a case in which the bill 40 that is to be conveyed before the transaction medium 50 exists within the temporary holding section 17, the adjusting of the order of the media is carried out by conveying that bill 40 from the temporary holding section 17 to the discriminating section 10, and thereafter, returning it to the temporary holding section 17 again.

Thereafter, the automatic transaction device 1, while conveying the transaction medium 50 at a low speed, carries out the processing of acquiring high-resolution image information of the transaction medium 50 at the image acquiring section 10a. Here, the control section 12 carries out switching that decreases the setting of the conveying speed of the conveying section 9 from a high speed (the standard speed) to a low speed. Further, the control section 12 carries out switching that increases the setting of the resolution of the image acquiring section 10a from the standard resolution to a high resolution. Note that, at this time, the automatic transaction device 1 may set the unillustrated magnetic sensor of the discriminating section 10 in an off state.

Next, at the automatic transaction device 1, the conveying section 9 conveys the transaction medium 50, that is accommodated in the temporary holding section 17, at a low speed to the discriminating section 10. At this time, the image acquiring section 10a of the discriminating section 10 acquires high-resolution image information of the both sides of the transaction medium 50.

Next, at the automatic transaction device 1, the image recognizing section 10b of the discriminating section 10 recognizes the stated contents of the transaction medium 50. At this time, the image recognizing section 10b recognizes the overall layout of the transaction medium 50 on the basis of the high-resolution image information of the entire transaction medium 50, and specifies the region where the barcode 51 is stated and regions where characters of the payee and the amount to be transferred and the like are stated, and, by executing optical character recognition processing (OCR processing) on these regions, recognizes the stated contents of the transaction medium 50.

Next, at the automatic transaction device 1, the conveying section 9 returns the transaction medium 50 to the temporary holding section 17 and accommodates it therein. The temporary holding section 17 accommodates the bills 40 and the transaction medium 50 until the transfer transaction processing is executed in the processing of S145 that is described later (concretely, until the “confirm (OK)” button of transaction content confirmation screen SC51, that is shown in FIG. 11E and is displayed on the display portion 2 in the processing of S140 that is described later, is pressed).

Thereafter, the control section 12 carries out switching that raises the setting of the conveying speed of the conveying section 9 from the low speed to a high speed (the standard speed). Further, at this time, the control section 12 carries out switching that lowers the setting of the resolution of the image acquiring section 10a from the high resolution to the standard resolution. Note that, at this time, if the unillustrated magnetic sensor of the discriminating section 10 is in an off state, the automatic transaction device 1 sets the magnetic sensor in an on state.

The processing of S135 is carried out in this way.

Note that, in the processing of S135, when the transfer transaction processing is executed in the processing of S145 that is described later (concretely, when the “confirm (OK)” button of the transaction content confirmation screen SC51, that is shown in FIG. 11E and is displayed on the display portion 2 in the processing of S140 that is described later, is pressed), the media (the bills 40 and the transaction medium 50) that are accommodated in the temporary holding section 17 are conveyed to the discriminating section 10, and thereafter, are conveyed to predetermined places.

Here, the “predetermined place” is the cassette of the corresponding denomination among the accommodating cassettes 19a˜19c if the medium is the bill 40 that can be recycled, and is the reject cassette 20 if the medium is the bill 40 that cannot be recycled, and is the cassette that has been set as the transaction media accommodating section 18, among the accommodating cassettes 19a˜19c and the reject cassette 20, if the medium is the transaction medium 50.

Note that, when the transfer transaction processing is not executed in the processing of S145 that is described later (concretely, when the “cancel” button of the transaction content confirmation screen SC51, that is shown in FIG. 11E and is displayed on the display portion 2 in the processing of S140 that is described later, is pressed), the automatic transaction device 1 conveys the bills 40 and the transaction medium 50, that are accommodated in the temporary holding section 17, to the media insert port 7a, and returns them to the remitter from the media insert port 7a.

Next, when the payee (i.e., the account that is the destination of movement of the cash information) and the stated amount of the transaction medium 50 are specified on the basis of the stated contents of the transaction medium 50 that the image recognizing section 10b recognized by the processing of S135, the control section 12 causes the display portion 2 to display the transaction content confirmation screen SC51 that is shown in FIG. 11E for example (S140).

The transaction content confirmation screen SC51 is a screen for making the remitter confirm the stated contents of the transaction medium 50 that were recognized by the image recognizing section 10b. In the example shown in FIG. 11E, the transaction content confirmation screen SC51 is structured to show, in contrast with one another, image picture Im11 of the transaction medium 50, and stated items Im12 that express the stated contents of the transaction medium 50 that were recognized by the image recognizing section 10b. Due thereto, the remitter can easily judge whether or not the stated contents of the transaction medium 50 that were recognized by the image recognizing section 10b are correct. Note that the stated items Im12 include items such as, for example, the payee and the stated amount (“invoiced amount” in the example shown in FIG. 11E) and the like that are stated on the transaction medium 50.

Further, the transaction content confirmation screen SC51 is structured such that inserted amount information IM13, that expresses the total amount of the cash (the coins and the bills 40) that was inserted, is disposed in a vicinity of the stated amount of the stated items Im12. Due thereto, the payee can know of the insufficiency of or the excess of the amount that was inserted, and can easily judge execution or cancellation of the transfer transaction processing.

Further, the transaction content confirmation screen SC51 is structured to include an “insert additional cash” button, a “cancel” button and a “confirm (OK)” button. Note that the transaction content confirmation screen SC51 may be structured to include guidance that requests confirmation of the transaction contents. The “insert additional cash” button is a button for carrying out the additional insertion of cash in a case in which the inserted amount is insufficient. The “cancel” button is a button for instructing cancellation of the transfer transaction processing. The “confirm (OK)” button is a button for definitizing the transaction contents and instructing movement to the next step (here, the execution of the transfer transaction processing). By pressing the “cancel” button or the “confirm (OK)” button, the remitter can instruct the automatic transaction device 1 to cancel or execute the transfer transaction processing.

In a case in which the remitter looks at the transaction content confirmation screen SC51, and the barcode 51 or the layout or the like of the transaction medium 50 have not been recognized correctly, the remitter presses the “cancel” button. In this case, the control section 12 senses the pressing of the “cancel button.

Thereupon, the automatic transaction device 1 conveys the bills 40 and the transaction medium 50, that are accommodated in the temporary holding section 17, from the temporary holding section 17 to the media insert port 7a, and returns them to the remitter from the media insert port 7a.

On the other hand, in a case in which the remitter looks at the transaction content confirmation screen SC51, and the barcode 51 and the layout and the like of the transaction medium 50 have been recognized correctly, the remitter presses the “confirm (OK)” button. Here, explanation is given while assuming a case in which the remitter presses the “confirm (OK)” button. In this case, the control section 12 senses the pressing of the “confirm (OK)” button.

Thereupon, the automatic transaction device 1 conveys the bills 40 and the transaction medium 50, that are accommodated in the temporary holding section 17, from the temporary holding section 17 to the discriminating section 10, and thereafter, conveys the respective media to the predetermined places in accordance with the results of recognition of the discriminating section 10.

At this time, the automatic transaction device 1 conveys the bills 40 that can be recycled to the cassettes of the corresponding denominations among the accommodating cassettes 19a˜19c and accommodates them therein, and conveys the bills 40 that cannot be recycled to the reject cassette 20 and accommodates them therein, and conveys the transaction medium 50 to the cassette, that was set as the transaction media accommodating section 18 among the accommodating cassettes 19a˜19c and the reject cassette 20, and accommodates it therein.

Then, the control section 12 asks the host computer for transfer transaction processing of the cash information of the stated amount to the account of the payee (the account that is the destination of movement) (S145). In response thereto, the host computer executes the transfer transaction processing.

At this time, in a case in which the total amount of the cash, that was inserted by the operator and includes coins and the bills 40, is greater than or equal to the stated amount of the transaction medium 50, the control section 12 executes the transaction processing that is based on the stated contents of the transaction medium 50.

On the other hand, in a case in which the total amount of the inserted cash is not greater than or equal to the stated amount of the transaction medium 50, the control section 12 causes the display portion 2 to display a screen that instructs the remitter to additionally insert cash. In this case, when the cash, that reaches the stated amount of the transaction medium 50, is additionally inserted within a given time, the control section 12 executes the transaction processing that is based on the stated contents of the transaction medium 50, and, on the other hand, when the cash, that reaches the stated amount of the transaction medium 50, is not additionally inserted within the given time, the control section 12 cancels the transaction processing that is based on the stated contents of the transaction medium 50.

Next, the control section 12 drives the journal section 11 and causes the journal section 11 to create a transaction record that relates to the transfer transaction processing (S150). At this time, the journal section 11 prints transaction record information in a journal, or stores transaction record information in the storage section 13.

Further, the control section 12 drives the receipt issuing section 5 and causes the receipt issuing section 5 to issue a receipt (S155). At this time, the receipt issuing section 5 (or the control section 12) cuts-out the image picture of the customer copy portion 63 (see FIG. 5 through FIG. 9), that was specified by the results of recognition of the layout of the transaction medium 50 at the image recognizing section 10b, from the acquired (imaged) image of the transaction medium 50 that was acquired in S135. Then, the receipt issuing section 5 copies the image picture of the customer copy portion 63 onto the medium for issuing that is readied in advance within the device, and prints the transaction content information and the image of the signature stamp on this medium for issuing. The receipt issuing section 5 thereby creates the receipt.

Here, the “transaction content information” means, as described above, information such as the transaction date and time and the payee, the transferred amount, and the like of the transfer transaction processing. Further the “image of the signature stamp” means, as described above, an image corresponding to the receipt stamp of the payment receiving agent company (in present embodiment 1, the financial institution or distribution institution that owns the automatic transaction device 1).

When the receipt issuing section 5 creates the receipt, the receipt issuing section 5 discharges the receipt to the exterior of the device. Due thereto, the remitter receives the receipt, that takes the place of the customer copy portion 63 (see FIG. 5 through FIG. 9), from the automatic transaction device 1.

After S155, in a case in which there are coins for change, the control section 12 drives an unillustrated conveying section for coins, and causes the coins for change to be conveyed to a place for coin return (e.g., the coin insert port of the coin handling section 8 (see FIG. 1) that also serves as a return port), and returns the coins to the remitter from that place (S160). Further, in a case in which there are the bills 40 for change, the control section 12 drives the conveying section 9, and causes the bills 40 for change to be conveyed to the media insert port 7a, and returns the bills 40 to the remitter from the media insert port 7a.

On the basis of the value of a sensing signal that is outputted from an unillustrated sensing sensor, the control section 12 monitors the receiving of the change by the remitter. When it is sensed that the remitter has received the change, the control section 12 ends the series of processings of the routine.

Note that, in the above-described judgment of S120, in a case in which the button that is pressed is not the button B21 for instructing execution of the transfer transaction processing by cash (here, the button that is pressed is the button B22 for instructing execution of the transfer transaction processing by the movement of cash information between two accounts, the case of “No”), as described above, the processing goes through reference numeral “A2” and proceeds to S305 of FIG. 10B.

In this case, the automatic transaction device 1 executes the transaction processing, that is based on the stated contents of the transaction medium 50 recognized by the discriminating section 10, by moving cash information between two accounts that are the account of the payer (i.e., the account that is the source of movement of the cash information) and the account of the payee (i.e., the account that is the destination of movement of the cash information).

In this case, the control section 12 first causes the display portion 2 to display a screen (not illustrated) that instructs the payer to insert a cash card or a passbook (S305). Then, the control section 12 causes unillustrated lamps, that are provided in vicinities of the insert port of the card handling section 4 (see FIG. 1) and the insert port of the passbook handling section 6 (see FIG. 1), to flash, or the like, and urges the payer to insert a card or a passbook into an insert port.

The processing of S305 means that, by making the payer insert a card or a passbook, the magnetic information that is recorded on the card or the passbook is read by the card handling section 4 or the passbook handling section 6, and, due thereto, the control section 12 is made to receive the designating of the account of the payer (the account that is the source of movement of cash information).

In accordance with the instructions of the guidance displayed on the screen, the remitter inserts a card or a passbook into the insert port. On the basis of the value of the sensed signal outputted from the unillustrated sensing sensor, the control section 12 monitors the insertion of a card or a passbook by the remitter. When the control section 12 senses that the remitter has inserted a card or a passbook, the control section 12 causes the display portion 2 to display a screen (not illustrated) that instructs the remitter to input the passcode (S310).

When the remitter inputs the passcode, the control section 12 causes the display portion 2 to display the per-type folding method explanation screen SC31 that is shown in FIG. 11C for example (S315), in the same way as in the processing of S125. Here, explanation is given of the remitter folding the transaction medium 50 in accordance with the instructions of the guidance displayed on the per-type folding method explanation screen SC31, and thereafter, pressing the “confirm (OK)” button.

When the control section 12 senses the pressing of the “confirm (OK)” button, the control section 12 causes the display portion 2 to display an insert screen (not illustrated) that instructs the remitter to insert the transaction medium 50 (S320). Then, the control section 12 causes the media handling section 7 to open the shutter 7b, and causes a lamp (not illustrated) that is provided in a vicinity of (or at the interior of) the media insert port 7a to flash, and urges the remitter to insert the transaction medium 50.

However, the insert screen that is displayed at this time has the contents of instructing the remitter to insert only the transaction medium 50. For example, the insert screen that is displayed at this time is structured such that statements and images relating to the bills 40 are excluded from the insert screen SC41 that is shown in FIG. 11D.

When the transaction medium 50 is inserted in the media insert port 7a, the control section 12 causes the media handling section 7 to take the transaction medium 50 into the device, and causes the discriminating section 10 to execute recognition processing of the stated contents of the transaction medium 50 (S325).

At this time, the automatic transaction device 1 must acquire high-resolution image information of the transaction medium 50 at the image acquiring section 10a while conveying the transaction medium 50 at a low speed. Thus, the control section 12 carries out switching that lowers the setting of the conveying speed of the conveying section 9 from a high speed (the standard speed) to a low speed. Further, the control section 12 carries out switching that raises the setting of the resolution of the image acquiring section 10a from the standard resolution to a high resolution. Due thereto, at the automatic transaction device 1, the image acquiring section 10a of the discriminating section 10 acquires high-resolution image information of both sides of the transaction medium 50 while the conveying section 9 conveys the transaction medium 50 at a low speed. Note that it suffices for the switching of the setting of the conveying speed of the conveying section 9 and the setting of the resolution of the image acquiring section 10a to be carried out at any point in time from S305 to S325.

Then, at the automatic transaction device 1, the image recognizing section 10b of the discriminating section 10 recognizes the stated contents of the transaction medium 50. At this time, the image recognizing section 10b recognizes the overall layout of the transaction medium 50 on the basis of the high-resolution image information of the transaction medium 50, and specifies the region where the barcode 51 is stated and regions where characters of the payee and the amount to be transferred and the like are stated, and, by executing optical character recognition processing (OCR processing) on these regions, recognizes the stated contents of the transaction medium 50.

Then, at the automatic transaction device 1, the conveying section 9 conveys the transaction medium 50 to the temporary holding section 17. The temporary holding section 17 temporarily accommodates the transaction medium 50 until the transfer transaction processing is executed.

Note that, at the automatic transaction device 1, when the transfer transaction processing is executed in the processing of S335 that is described later (concretely, when the “confirm (OK)” button of the transaction content confirmation screen SC51, that is shown in FIG. 11E and is displayed on the display portion 2 in the processing of S330 that is described later, is pressed), the transaction medium 50 that is accommodated in the temporary holding section 17 is conveyed from the temporary holding section 17 via the discriminating section 10 to the cassette, that has been set as the transaction media accommodating section 18 among the accommodating cassettes 19a˜19c and the reject cassette 20, and is accommodated therein.

Further, at the automatic transaction device 1, when the transfer transaction processing is not executed in the processing of S335 that is described later (concretely, when the “cancel” button of the transaction content confirmation screen SC51, that is shown in FIG. 11E and is displayed on the display portion 2 in the processing of S330 that is described later, is pressed), the transaction medium 50 that is accommodated in the temporary holding section 17 is conveyed from the temporary holding section 17 to the media insert port 7a, and is returned to the remitter from the media insert port 7a.

Next, in the same way as in S140, when the payee (i.e., the account that is the destination of movement of the cash information) and the stated amount of the transaction medium 50 are specified on the basis of the stated contents of the transaction medium 50 that the image recognizing section 10b recognized by the processing of S325, the control section 12 causes the display portion 2 to display the transaction content confirmation screen SC51 that is shown in FIG. 11E for example (S330). Here, description is given while assuming a case in which the remitter presses the “confirm (OK)” button.

After S330, in the same way as in S145, when the control section 12 senses pressing of the “confirm (OK)” button, the control section 12 asks the host computer for transfer transaction processing of the cash information of the stated amount to the account of the payee (the account that is the destination of movement) (S335). In response thereto, the host computer executes the transfer transaction processing.

At this time, the host computer confirms the balance of the account of the payer (the account that is the source of the movement of the cash information), and judges whether or not the balance of the account of the payer is greater than or equal to the stated amount. In a case in which the balance of the account of the payer is greater than or equal to the stated amount, the host computer executes the transfer transaction processing.

On the other hand, in a case in which balance of the account of the payer is not greater than or equal to the stated amount, the host computer cancels the transfer transaction processing. Then, the host computer notifies the automatic transaction device 1 of the results of execution or cancellation of the transfer transaction processing. Here, description is given while assuming a case in which the host computer has executed the transfer transaction processing.

After S335, in the same way as in S150, the control section 12 drives the journal section 11 and causes the journal section 11 to create a transaction record that relates to the transfer transaction processing (S340). Further, in the same way as in S155, the control section 12 drives the receipt issuing section 5, and causes the receipt issuing section 5 to issue a receipt (S345).

After S345, in a case in which there is change, the control section 12 causes the display portion 2 to display, for example, a screen that causes the remitter to select the execution of either one processing among a processing of discharging the change to the exterior of the device and a processing of depositing the change in the account of the payer (hereinafter called “change handling selection screen (not illustrated)”) (S350).

When the change handling selection screen is displayed on the display portion 2, the remitter, in accordance with the instructions of the guidance displayed on the screen, selects and presses a button that instructs execution of either one of the processings.

When the control section 12 senses pressing of a button, the control section 12 judges whether or not the pressed button is the button for instructing execution of the processing of discharging the change to the exterior of the device (S355).

In the judgment of S355, in a case in which the pressed button is the button for instructing execution of the processing of discharging the change to the exterior of the device (the case of “Yes”), the control section 12 executes processing that is similar to the processing of S160, and discharges the change (S360).

On the other hand, in the judgment of S355, in a case in which the pressed button is not the button for instructing execution of the processing of discharging the change to the exterior of the device (i.e., the pressed button is the button for instructing execution of the processing of depositing the change in the account of the payer, the case of “No”), the control section 12 asks the host computer for a deposit transaction processing of cash information, that is in the amount of the change, into the account of the payer (the account that is the source of movement) (S365). In response thereto, the host computer executes the deposit transaction processing. When the processing of S360 or the processing of S365 is executed, the control section 12 ends the series of processings of the routine.

In this structure, the automatic transaction device 1 is a mechanism that handles the bills 40, and can also handle the transaction medium 50. Therefore, the automatic transaction device 1 can reduce the number of structural elements that are exclusively used for handling the transaction medium 50 and that are provided at a conventional automatic transaction device (e.g., an insert port exclusively used for the insertion of the transaction medium 50 into the device, a recognizing section exclusively used for recognizing the stated contents of the transaction medium 50, a conveying section and a conveying path exclusively used for conveying the transaction medium 50 from the insert port to the recognizing section, and the like). Due thereto, the automatic transaction device 1 can suppress an increase in manufacturing cost.

Further, due to the automatic transaction device 1 causing the transaction medium 50 to be inserted into the same media insert port 7a as the bills 40, an increase in the number of insert ports can be avoided. Therefore, it is easy to understand which insert port the transaction medium 50 should be inserted into, and the operation time of the device monopolized per remitter (operator) can be shortened.

Further, before starting of the transaction processing, in S105, the control section 12 of the automatic transaction device 1 causes the display portion 2 to display the transaction select screen SC11 in which transaction processings, that are based on the stated contents of the transaction medium 50, are included as candidates of transaction processings that can be selected. Due thereto, the remitter (the operator) can instruct the automatic transaction device 1 to execute a transaction processing that is based on the stated contents of the transaction medium 50.

As described above, in accordance with the automatic transaction device 1 relating to present embodiment 1, the number of structural elements that are exclusively used for handling the transaction medium 50 can be reduced, and therefore, a structure, that executes a transaction processing that is based on the transaction medium 50, can be realized at a relatively low cost.

### Embodiment 2

The automatic transaction device 1 relating to embodiment 1 is a structure in which the remitter is made to fold the transaction medium 50 and insert the transaction medium 50 into the media insert port 7a. However, at the automatic transaction device 1 relating to embodiment 1, because it is difficult to understand the way of folding the transaction medium 50 per type, there is the possibility that the remitter may become confused.

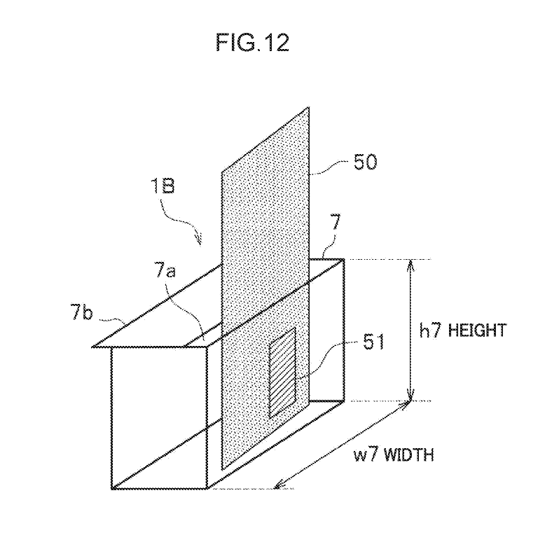

Thus, present embodiment 2 provides an automatic transaction device 1B that does not require folding of the transaction medium 50. The characteristics of the automatic transaction device 1B relating to the present second embodiment are described hereinafter with reference to FIG. 12. FIG. 12 is a drawing showing the way of inserting, into the media insert port 7a, the transaction medium 50 of the automatic transaction device 1B relating to the present second embodiment.

As shown in FIG. 12, the automatic transaction device 1B relating to present embodiment 2 is structured so as to, at the time of insertion of the transaction medium 50 into the media insert port 7a, cause the shutter 7b to open partially, and cause the transaction medium 50 to be inserted into the gap between the partially-opened shutter 7b and the media insert port 7a.

Namely, in order for the bills 40 and the transaction medium 50 to be inserted separately, the automatic transaction device 1B is structured such that, at the time when the bills 40 are to be inserted into the media insert port 7a, the media insert port 7a is opened completely, and, on the other hand, at the time when the transaction medium 50 is to be inserted into the media insert port 7a, the media insert port 7a is opened partially.

Note that, at the transaction medium 50, preferably, it is good for the barcode 51 (i.e., the barcode surface of the main copy portion 61 (see FIG. 5 through FIG. 9)) to always face in a given direction (e.g., in the example shown in FIG. 12, the direction facing the remitter). Accordingly, it is good for the insert screen, that instructs the remitter to insert the transaction medium 50, to be structured so as to make the barcode 51 always face in the given direction.

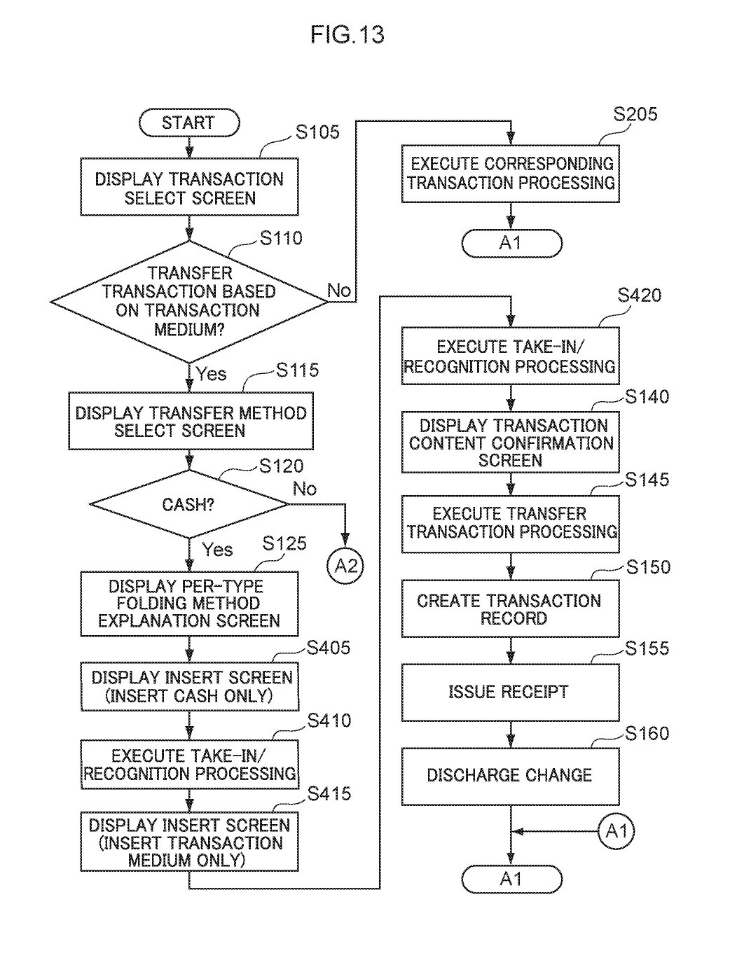

Operation of the automatic transaction device 1B relating to present embodiment 2 is described hereinafter with reference to FIG. 13. FIG. 13 is a flowchart showing operations of the automatic transaction device relating to present embodiment 2.

Here, with regard to the operations of the automatic transaction device 1B relating to present embodiment 2, explanation is given predominately of the operations that differ from the automatic transaction device 1 relating to embodiment 1, and, with regard to the operations that are similar to the automatic transaction device 1 relating to embodiment 1 (see FIG. 10A and FIG. 10B), the operations of the automatic transaction device 1 relating to above-described embodiment 1 can be read as being operations of the automatic transaction device 1B relating to present embodiment 2, and detailed description thereof is omitted.

As shown in FIG. 13, in comparison with the automatic transaction device 1 relating to embodiment 1, the operations of the automatic transaction device 1B relating to present embodiment 2 differ with regard to the point that processings of S405 through S420 are executed instead of the processings of S130 through S135.

Namely, at the automatic transaction device 1B relating to present embodiment 2, after S125, when the control section 12 senses pressing of the “confirm (OK)” button, the control section 12 causes the display portion 2 to display an insert screen that instructs insertion of cash only (hereinafter called “bill insert screen (not illustrated)”) (S405). Note that, at this time, the conveying speed of the conveying section 9 is set to a high speed (the standard speed). Further, the resolution of the image acquiring section 10a is set to the standard resolution.

After S405, when the bills 40 are inserted in the media insert port 7a, the control section 12 causes the bills 40 to be taken into the device while being separated one-by-one, and causes the discriminating section 10 to execute recognition processing on each of the bills 40 (S410).

At this time, if there is the bill 40 whose denomination was not confirmed by the recognition at the discriminating section 10, the control section 12 drives the conveying section 9, and causes the conveying section 9 to return the bill 40 whose denomination was not confirmed to the media insert port 7a, and causes execution of similar processings again. Then, in a case in which the bill 40 whose denomination was not confirmed exists even after a similar processing is repeated a predetermined number of times, the control section 12 returns the bill 40 whose denomination was not confirmed to the remitter from the media insert port 7a, and in its place, receives the additional insertion of the bill 40, and repeats processings that are similar to those described above.

After S410, the control section 12 causes the display portion 2 to display an insert screen that instructs insertion of the transaction medium 50 only (hereinafter called “transaction medium insert screen (not illustrated)”) (S415). Note that, at this time, the control section 12 carries out switching that lowers the setting of the conveying speed of the conveying section 9 from a high speed (the standard speed) to a low speed. Further, the control section 12 carries out switching that raises the setting of the resolution of the image acquiring section 10a from the standard resolution to a high resolution. Moreover, the control section 12 drives the media handling section 7, and causes the media handling section 7 to partially open the shutter 7b to the extent that the transaction medium 50 can be inserted therein.

The transaction medium insert screen (not illustrated) has contents that instruct the remitter to insert the transaction medium 50 such that the barcode 51 (i.e., the barcode surface of the main copy portion 61 (see FIG. 5 through FIG. 9)) always faces in a given direction (e.g., in the example shown in FIG. 12, the direction facing the remitter) and the leading end portion of the transaction medium 50 is inserted in the media insert port 7a. In accordance with the transaction medium insert screen (not illustrated), the remitter inserts the leading end portion of the transaction medium 50 into the media insert port 7a.

After S415, when the transaction medium 50 is inserted in the media insert port 7a, the control section 12 causes the media handling section 7 to take the transaction medium 50 into the device, and causes the discriminating section 10 to execute recognition processing of the transaction medium 50 (S420).

At this time, at the automatic transaction device 1, while the conveying section 9 conveys the transaction medium 50 at a low speed, the image acquiring section 10a of the discriminating section 10 acquires high-resolution image information of both sides of the transaction medium 50 (or high-resolution image information of only the barcode surface), and, on the basis of the high-resolution image information of the barcode surface of the transaction medium 50, the image recognizing section 10b of the discriminating section 10 recognizes the stated contents of the transaction medium 50. Thereafter, the automatic transaction device 1B executes processings that are similar to the automatic transaction device 1 relating to embodiment 1.

Note that, in a case in which the transfer transaction processing is cancelled, the automatic transaction device 1B must return the transaction medium 50 to the remitter. Further, in the state in which the shutter 7b is partially opened, when the automatic transaction device 1B returns the transaction medium 50 to the media insert port 7a in order to return the transaction medium 50 to the remitter, there is the possibility that the transaction medium 50 will collide with the shutter 7b and the transaction medium 50 will bend at the interior of the media insert port 7a.

Thus, the automatic transaction device 1B temporarily holds the transaction medium 50 on the conveying path 15 without returning the transaction medium 50 to the media insert port 7a, until the transfer transaction processing is executed (concretely, until the “confirm (OK)” button of the transaction content confirmation screen SC51, that is shown in FIG. 11E and is displayed on the display portion 2 in the processing of S140, is pressed).

Then, in a case in which the transfer transaction processing is executed (concretely, in a case in which the “confirm (OK)” button of the transaction content confirmation screen SC51, that is shown in FIG. 11E and is displayed on the display portion 2 in the processing of S140, is pressed), the automatic transaction device 1B conveys the transaction medium 50, that is held on the conveying path 15, to the transaction media accommodating section 18.

On the other hand, in a case in which the transfer transaction processing is cancelled (concretely, in a case in which the “cancel” button of the transaction content confirmation screen SC51, that is shown in FIG. 11E and is displayed on the display portion 2 in the processing of S140, is pressed), the automatic transaction device 1B opens the shutter 7b completely, and returns the transaction medium 50, that is held on the conveying path 15, to the media insert port 7a, and sends the leading end of the transaction medium 50 out to the exterior of the device from the media insert port 7a. Due thereto, the automatic transaction device 1B returns the transaction medium 50 to the remitter.

Then, when the remitter takes the transaction medium 50 out from the media insert port 7a, the automatic transaction device 1B closes the shutter 7b once, and conveys the bills 40 from the temporary holding section 17 to the media insert port 7a, and stacks the bills 40 in the media insert port 7a, and opens the shutter 7b. Due thereto, the automatic transaction device 1B returns the bills 40 to the remitter.

As described above, in accordance with the automatic transaction device 1B relating to present embodiment 2, in the same way as the automatic transaction device 1 relating to embodiment 1, the number of structural elements that are exclusively used for handling the transaction medium 50 can be reduced, and therefore, a structure, that executes a transaction processing that is based on the transaction medium 50, can be realized at a relatively low cost.

Moreover, in accordance with the automatic transaction device 1B relating to present embodiment 2, the transaction medium 50 can be inserted in the media insert port 7a in a state of being spread straight out without being folded. Therefore, the remitter can operate the device without becoming confused.

### Embodiment 3

The automatic transaction device 1B relating to embodiment 2 is a structure in which, as shown in FIG. 12, the transaction medium 50 is inserted into the media insert port 7a in a state of being spread straight out without being folded. Further, the automatic transaction device 1B recognizes the stated contents of the transaction medium 50 by acquiring a high-resolution image of the entire transaction medium 50 and executing optical character recognition processing (OCR processing) on the acquired high-resolution image of the entire transaction medium 50.

This automatic transaction device 1B acquires a high-resolution image of, in addition to a portion where detailed optical character recognition processing is required (hereinafter called “portion requiring detailed recognition”), also a portion where detailed optical character recognition processing is not required (hereinafter called “portion not requiring detailed recognition”). Here, a “portion where detailed optical character recognition processing is required (portion requiring detailed recognition)” means, for example, the region where the barcode 51 of the main copy portion 61 (see FIG. 5) is stated, and the region where characters of the payee and the amount to be transferred and the like are stated, and the like. Further, a “portion where detailed optical character recognition processing is not required (portion not requiring detailed recognition)” is a portion other than the main copy portion 61, and means, for example, a portion such as the store copy portion 62 (see FIG. 5) or the customer copy portion 63 (see FIG. 5) or the like.

Accordingly, at the automatic transaction device 1B relating to embodiment 2, a high-resolution image is acquired also for a portion not requiring detailed recognition, and therefore, the image amount that is acquired is large, and a relatively large-capacity memory must be provided at the discriminating section 10.

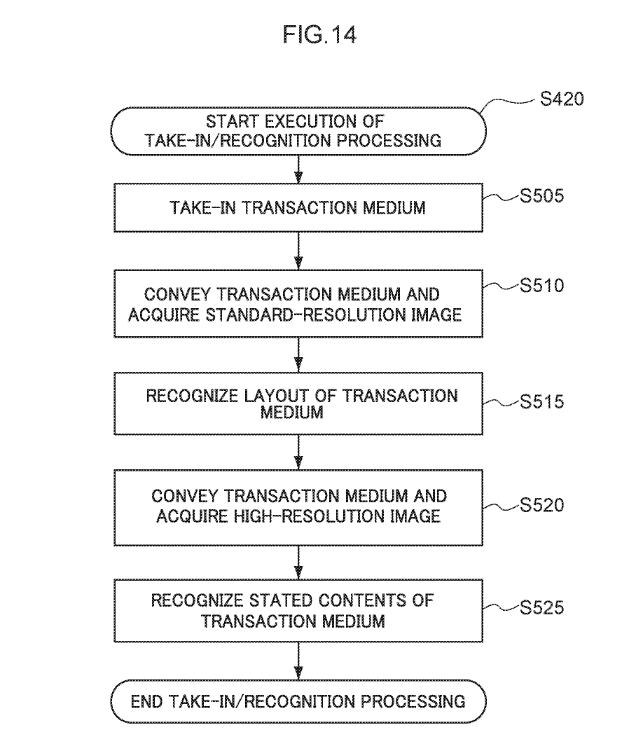

Thus, present embodiment 3 provides an automatic transaction device 1C (not illustrated) that recognizes the stated contents of the transaction medium 50, without providing a relatively large-capacity memory at the discriminating section 10. Hereinafter, the characteristics of the automatic transaction device 1C relating to present embodiment 3 are described with reference to FIG. 14.

FIG. 14 is a flowchart showing operations of the automatic transaction device 1C (not illustrated) relating to present embodiment 3. As compared with the automatic transaction device 1B relating to embodiment 2, the automatic transaction device 1C relating to present embodiment 3 differs with regard to the point that the processings of S505 through S525 that are shown in FIG. 14 are executed in the processing of S420 (the processing of “execute take-in/recognition processing”).

Namely, in the processing of S420, the automatic transaction device 1B relating to embodiment 2 acquires a high-resolution image of the entire transaction medium 50 (the entire barcode surface) including portions not requiring detailed recognition, and executes optical character recognition processing on the acquired high-resolution image of the entire transaction medium 50.

In contrast, the automatic transaction device 1C (not illustrated) relating to present embodiment 3 executes the processings of following S505 through S525 in the processing of S420.

For example, at the automatic transaction device 1C, when the transaction medium 50 is inserted in the media insert port 7a by the remitter (the operator), the media handling section 7 takes the transaction medium 50 from the media insert port 7a into the interior of the device (S505), and the conveying section 9 conveys the transaction medium 50 from the media insert port 7a toward the discriminating section 10, and causes the transaction medium 50 to pass through the discriminating section 10, and further, conveys the transaction medium 50 to the temporary holding section 17. At this time, at the time when the transaction medium 50 passes-through the discriminating section 10, the image acquiring section 10a of the discriminating section 10 acquires a standard-resolution image of the entire transaction medium 50 (the entire barcode surface) including portions not requiring detailed recognition (S510). Then, the image acquiring section 10a outputs the acquired standard-resolution image of the entire transaction medium 50 to the image recognizing section 10b.

When the standard-resolution image of the entire transaction medium 50 is inputted from the image acquiring section 10a, the image recognizing section 10b executes optical character recognition processing on the standard-resolution image of the entire transaction medium 50. At this time, on the basis of the densities of the white regions and the black regions that are included in the standard-resolution image, and characteristics such as the barcode 51 and ruled lines and the like, the image recognizing section 10b recognizes the layout of the entire transaction medium 50 (the entire barcode surface) (S515), and specifies the main copy portion 61 (see FIG. 5) in which portions requiring detailed recognition (the region where the barcode 51 is stated, and the region where characters of the payee and the amount to be transferred and the like are stated) are included.

Next, at the automatic transaction device 1C, the conveying section 9 conveys the transaction medium 50 in the opposite direction from the temporary holding section 17 toward the discriminating section 10, and passes the transaction medium 50 through the discriminating section 10. At this time, when the transaction medium 50 passes through the discriminating section 10, the image acquiring section 10a of the discriminating section 10 acquires high-resolution images of only the portions requiring detailed recognition of the transaction medium 50 (S520). Then, the image acquiring section 10a outputs, to the image recognizing section 10B, the acquired high-resolution images of only the portions requiring detailed recognition of the transaction medium 50.

When the high-resolution images of only the portions requiring detailed recognition of the transaction medium 50 are inputted from the image acquiring section 10a, the image recognizing section 10b executes optical character recognition processing on the high-resolution images of only the portions requiring detailed recognition of the transaction medium 50. Due thereto, the image recognizing section 10b recognizes the stated contents of the transaction medium 50 (S525). In this way, the automatic transaction device 1C relating to present embodiment 3 executes the processing of S420 (the processing of “execute take-in/recognition processing”).

Note that the automatic transaction device 1C (not illustrated) relating to present embodiment 3 can be realized by, for example, executing the following processings. Namely, for example, at the automatic transaction device 1C, at the time of the processing of S415 shown in FIG. 13 (“the processing of display insert screen (insert transaction medium only)”), the leading end portion of the transaction medium 50 is inserted in the media insert port 7a as shown in FIG. 12. At this time, at the automatic transaction device 1C, the discriminating section 10 sets the resolution to a high resolution, and acquires the image that is from the leading end portion of the transaction medium 50 to the main copy portion 61 (see FIG. 5 through FIG. 9) (e.g., the image of the region that is up to around 130 mm from the leading end portion of the transaction medium 50) as a high-resolution image, and thereafter, switches the resolution from a high resolution to the standard resolution, and acquires the image of the portion other than the main copy portion 61 as a standard-resolution image. The automatic transaction device 1C (not illustrated) can be realized by this as well.

As described above, in accordance with the automatic transaction device 1C (not illustrated) relating to present embodiment 3, in the same way as the automatic transaction device 1 relating to embodiment 1 and the automatic transaction device 1B relating to embodiment 2, the number of structural elements that are exclusively used for handling the transaction medium 50 can be reduced, and therefore, a structure, that executes a transaction processing that is based on the transaction medium 50, can be realized at a relatively low cost.

Moreover, in accordance with the automatic transaction device 1C (not illustrated) relating to present embodiment 3, in the same way as the automatic transaction device 1B relating to embodiment 2, the transaction medium 50 can be inserted in the media insert port 7a in a state of being spread straight out without being folded. Therefore, the remitter can operate the device without becoming confused.

Moreover, in accordance with the automatic transaction device 1C (not illustrated) relating to present embodiment 3, a high-resolution image of the portion requiring detailed recognition is acquired without acquiring a high-resolution image of a portion not requiring detailed recognition. Therefore, the image amount that is acquired can be made to be small, and a memory of a relatively small capacity can be used at the discriminating section 10.

The present invention is not limited to the above-described embodiments, and various changes and modifications can be made within a scope that does not depart from the gist of the present invention.

For example, the present invention can also be applied to an automatic transaction device that is already in widespread use, by replacing internal units (in particular, the memories (or storage media) that store the programs thereof) of portions of the discriminating section 10 and the like, or merely by updating the control program of the control section 12.

Further, for example, in the above-described embodiments, description is given by using, as an example, a case in which the one transaction medium 50 is inserted. However, the automatic transaction device 1 can be made such that plural transaction media 50 are inserted simultaneously.

Further, the discriminating section 10 can be made to be the following structure for example. Namely, the discriminating section 10 can be made to be a structure in which the image acquiring section 10a acquires standard-resolution images of the bills 40 and a high-resolution image of the transaction medium 50, and the image recognizing section 10b recognizes the denominations of the bills 40 on the basis of the standard-resolution images of the bills 40, and recognizes the layout and the stated contents of the transaction medium 50 on the basis of the high-resolution image of the transaction medium 50.

Further, the discriminating section 10 can be made to be the following structure for example. Namely, the discriminating section 10 can be made to be a structure in which the image acquiring section 10a acquires standard-resolution images of the bills 40 and a standard-resolution image of the transaction medium 50 and a high-resolution image of the transaction medium 50, and the image recognizing section 10b recognizes the denominations of the bills 40 on the basis of the standard-resolution images of the bills 40, and recognizes the layout of the transaction medium 50 on the basis of the standard-resolution image of the transaction medium 50, and recognizes the stated contents of the transaction medium 50 on the basis of the high-resolution image of the transaction medium 50. In this case, the discriminating section 10 acquires, at a high resolution, only an image of a portion where a detailed image is required, and acquires, at the standard resolution, an image of a portion where a detailed image is not required (i.e., an image of a portion that can be processed at the standard resolution). Therefore, the automatic transaction device 1 can reduce the used amount of the memory of the discriminating section 10.

Further, the discriminating section 10 can be made to be the following structure for example. Namely, the discriminating section 10 can be made to be a structure in which (a) the image acquiring section 10a acquires an image of the entire transaction medium 50 as a standard-resolution image, and the image recognizing section 10b recognizes the layout of the transaction medium 50 on the basis of the standard-resolution image, and (b) further, the image acquiring section 10a acquires an image of a specific place of the transaction medium 50 as a high-resolution image, and the image recognizing section 10b recognizes the stated contents of the transaction medium 50 on the basis of the high-resolution image. In this case, the discriminating section 10 acquires, at a high resolution, only the image of a portion where a detailed image is required, and acquires, at the standard resolution, the image of a portion where a detailed image is not required (i.e., the image of a portion that can be processed at the standard resolution). Therefore, the automatic transaction device 1 can reduce the used amount of the memory of the discriminating section 10.

Further, for example, preferably, it is good for the automatic transaction device 1 to be structured such that the direction of inserting the transaction medium 50 into the media insert port 7a is prescribed in advance, and, at the transaction medium 50 insert screen (e.g., the insert screen SC41 shown in FIG. 11D), the remitter is instructed to make the barcode surface of the transaction medium 50 always face in a given direction. Due thereto, the automatic transaction device 1 can improve the processing speed of the discriminating section 10.

Further, for example, in the above-described embodiments, description is given by using, as an example, a case in which the automatic transaction device 1 executes a transfer transaction processing by using the transaction medium 50 that is of a form shown in FIG. 5 through FIG. 9. However, the automatic transaction device 1 can execute processing similarly by using an unillustrated, exclusive-use transfer form (a transaction medium that is other than the forms shown in FIG. 5 through FIG. 9) that is used in financial institutions such as a bank or the post office or the like.

Further, for example, in the above-described embodiments, the automatic transaction device 1 is structured such that the transaction medium 50 and the bills 40 are inserted into the common media insert port 7a. However, the automatic transaction device 1 may be structured such that an insert port for the transaction medium 50 is provided directly above or directly below an insert port for the bills 40, and the transaction medium 50 is conveyed on the same conveying path 15 as the bills 40.

Further, for example, in the above-described embodiments, the discriminating section 10 is structured so as to recognize the stated contents of the transaction medium 50. However, the automatic transaction device 1 may be structured such that the control section 12 recognizes the stated contents of the transaction medium 50. This structure is realized, for example, by a control program of the following structure being stored in advance in the storage section 13, and by causing the discriminating section 10 to output, to the control section 12, the acquired image of the transaction medium 50 that was acquired at the image acquiring section 10a. This control program is structured such that, on the basis of the acquired image that the image acquiring section 10a acquired, the control program causes the control section 12 to identify whether a medium is the bill 40 or is the transaction medium 50, and, when the medium is identified to be the bill 40, causes the control section 12 to recognize the denomination thereof, and, on the other hand, when the medium is identified to be the transaction medium 50, causes the control section 12 to recognize the stated contents thereof, and also, causes the control section 12 to execute the transfer transaction processing on the basis of the stated contents that were recognized.

Further, for example, the above-described embodiments describe, as an example, a case in which the automatic transaction device 1 executes a transfer transaction processing by using the transaction medium 50 that is of a form shown in FIG. 5 through FIG. 9. However, the automatic transaction device 1 may execute a deposit transaction processing, that uses a “check” as the transaction medium 50 that is other than this, or the like.

In this case, first, a button for instructing execution of a deposit transaction processing using a check as the transaction medium 50, is added to the transaction select screen SC11 in the drawing of FIG. 11A. Due to the button for deposit transaction processing using a check being pressed by the operator, the control section 12 executes a transaction processing that corresponds to the pressed button. Next, a screen that urges insertion of the check into the insert port is displayed in the transaction medium 50 insert screen (e.g., the insert screen SC41 shown in FIG. 11D). Note that, in a deposit transaction processing that uses a check, practical application thereof, that is such that a check is inserted into the automatic transaction device 1 in a state of being placed within a predetermined envelope in advance, also can be considered. In this case, before the transaction medium 50 insert screen is displayed, a guide screen, that guides insertion of a check into a predetermined envelope or the way of inserting a check into an envelope, may be displayed instead of the per-type folding explanation screen SC31 that is shown in FIG. 11C. Thereafter, in the same way as in the above-described embodiments, the discriminating section 10 recognizes the stated contents of the transaction medium 50, and, on the basis of the recognized contents, the control section 12 may display a transaction content confirmation screen SCcheck such as shown in FIG. 11E and promote the deposit transaction processing.

By doing so, in the same way as in the above-described embodiments, the number of structural elements that are exclusively used for handling a check as the transaction medium can be reduced. Note that, in a case in which a check will not fit into the insert port, this structure may be combined with above-described embodiment 2.

[Additional Remarks]

The automatic transaction device relating to the present invention may be structured such that the discriminating section acquires a standard-resolution image of a medium and a high-resolution image of a medium, and recognizes the denomination of a bill on the basis of the standard-resolution image, and recognizes the layout of a transaction medium on the basis of the standard-resolution image, and recognizes the stated contents of the transaction medium on the basis of the high-resolution image.

Further, the automatic transaction device relating to the present invention can be structured such that the direction of insertion of the transaction medium at the media insert port is prescribed, and the discriminating section acquires an image of the entire medium as a standard-resolution image, and recognizes the layout of the transaction medium on the basis of the standard-resolution image, and moreover, acquires an image of a specific place of the transaction medium as a high-resolution image, and recognizes the stated contents of the transaction medium on the basis of the high-resolution image.

Further, in the automatic transaction device relating to the present invention, the insert screen can be structured so as to have the contents that bills and a transaction medium are to be inserted simultaneously and in a superposed manner

Further, in the automatic transaction device relating to the present invention, the insert screen can be structured so as to have the contents that bills and a transaction medium are to be inserted separately.

Further, a program relating to the present invention is a program that causes execution by a control section of an automatic transaction device that communicates with a host computer and executes various types of transaction processings and includes a media insert port into which media are inserted, a conveying section that conveys media that have been inserted in the media insert port, a discriminating section that, on the basis of an image of a conveyed medium, identifies whether the medium is a bill or is a transaction medium, and, when the medium is identified as a bill, recognizes a denomination thereof, and, on the other hand, when the medium is identified as a transaction medium, recognizes stated contents thereof, a temporary holding section that temporarily accommodates media, a bill accommodating section that accommodates bills, a transaction media accommodating section that accommodates transaction media, and the control section that executes a transaction processing, and the program can be structured so as to cause the control section to drive the conveying section and cause the conveying section to convey the medium, that was inserted in the media insert port, to the discriminating section, and to convey a medium, that was recognized as an authentic bill or as a transaction medium by the discriminating section, to the temporary holding section and accommodate the medium therein, and to return a medium, that was not recognized as an authentic bill or as a transaction medium, to the media insert port, and, after a transaction is definitized, to drive the conveying section and cause the conveying section to convey a medium, that was recognized as an authentic bill among the media accommodated in the temporary holding section, to the bill accommodating section and accommodate the medium therein, and to convey a medium, that was recognized as a transaction medium, to the transaction media accommodating section and accommodate the medium therein.

Further, a program relating to the present invention is a program that causes execution by a control section of an automatic transaction device that communicates with a host computer and executes various types of transaction processings and includes the control section that executes a transaction processing on the basis of stated contents of a transaction medium, and a display portion that displays various types of information, and the program can be structured so as to cause the control section to cause the display portion to display a screen instructing an operator to insert the transaction medium into an insert port of bills.

Further, a program relating to the present invention is a program that causes execution by a discriminating section that is provided on a conveying path, on which media are conveyed, of an automatic transaction device that communicates with a host computer and executes various types of transaction processings, and the discriminating section recognizes denominations of bills and stated contents of a transaction medium, and the program can be structured so as to cause the discriminating section to, on the basis of an image of a medium that is conveyed on the conveying path, identify whether the medium is a bill or is a transaction medium, and to recognize the denomination thereof when the medium is identified to be a bill, and, on the other hand, to recognize the stated contents thereof when the medium is identified to be a transaction medium.

The disclosure of Japanese Patent Application No. 2014-067257 is, in its entirety, incorporated by reference into the present specification.

All publications, patent applications, and technical standards mentioned in the present specification are incorporated by reference into the present specification to the same extent as if such individual publication, patent application, or technical standard was specifically and individually indicated to be incorporated by reference.

1. An automatic transaction device that communicates with a host computer and executes various types of transaction processings, comprising:
a media insert port into which media are inserted;
a conveying section that conveys media that have been inserted in the media insert port;
a discriminating section that identifies whether the conveyed medium is a bill or is a transaction medium, and, when the medium is identified to be a bill, recognizes a denomination thereof, and, on the other hand, when the medium is identified to be a transaction medium, recognizes stated contents thereof; and
a control section that executes a transaction processing on the basis of the stated contents that the discriminating section recognized.

2. The automatic transaction device of claim 1, wherein the discriminating section acquires an image of the conveyed medium, and, on the basis of the acquired image, identifies whether the medium is a bill or is a transaction medium, and, when the medium is identified to be a transaction medium, recognizes the stated contents from the acquired image.

3. The automatic transaction device of claim 1, wherein the discriminating section acquires a standard-resolution image of the bill and a high-resolution image of the transaction medium, and recognizes the denomination of the bill on the basis of the standard-resolution image of the bill, and recognizes a layout and the stated contents of the transaction medium on the basis of the high-resolution image of the transaction medium.

4. The automatic transaction device of claim 1, wherein the conveying section individually separates and conveys the bill and the transaction medium that were inserted at the same time.

5. The automatic transaction device of claim 4, further comprising a temporary holding section that temporarily accommodates the medium, a bill accommodating section that accommodates the bill, and a transaction media accommodating section that accommodates the transaction medium,
wherein the control section causes the conveying section to convey a medium, that has been inserted in the media insert port, to the discriminating section, and to convey a medium, that was recognized as an authentic bill or the transaction medium by the discriminating section, to the temporary holding section and accommodate the medium therein, and to return a medium, that was not recognized as the authentic bill or the transaction medium, to the media insert port, and
after a transaction is definitized, the control section causes the conveying section to, among the media accommodated in the temporary holding section, convey a medium that was recognized as the authentic bill to the bill accommodating section and accommodate the medium therein, and convey a medium that was recognized as the transaction medium to the transaction media accommodating section and accommodate the medium therein.

6. The automatic transaction device of claim 1, wherein
the media insert port is opened completely at a time of insertion of the bill, and, on the other hand, is opened partially at a time of insertion of the transaction medium, and
the conveying section successively conveys media that have been inserted in the media insert port.

7. The automatic transaction device of claim 1, wherein the control section specifies a stated amount of the transaction medium on the basis of the stated contents that the discriminating section recognized, and, in a case in which a total amount of cash inserted by an operator including coins and the bills is greater than or equal to the stated amount, the control section executes a transaction processing that is based on the stated contents that the discriminating section recognized, and, on the other hand, in a case in which a total amount of the inserted cash is not greater than or equal to the stated amount, the control section cancels the transaction processing that is based on the stated contents that the discriminating section recognized.

8. The automatic transaction device of claim 1, wherein
in a case in which execution, by movement of cash information between two accounts, of a transaction processing that is based on the stated contents that the discriminating section recognized is instructed by an operator,
the control section receives designation, by the operator, of an account that is a source of movement of the cash information, and opens the media insert port and receives insertion of the transaction medium, and
on the basis of the stated contents that the discriminating section recognized, the control section specifies an account that is a destination of movement of the cash information and a stated amount of the transaction medium, and asks the host computer to move cash information, of an amount corresponding to the stated amount, from the account that is the source of movement to the account that is the destination of movement.

9. The automatic transaction device of claim 1, further comprising a receipt issuing section that issues a receipt in a case in which a transaction processing, that is based on the stated contents that the discriminating section recognized, is executed,
wherein the receipt issuing section creates the receipt by copying an image of the transaction medium onto a medium for issuing that has been readied in advance within the device, and printing transaction content information, that includes a transaction date and time, and an image of a signature stamp onto the medium for issuing.

10. The automatic transaction device of claim 1, wherein, before starting a transaction processing, the control section causes a display portion to display a transaction selection screen in which a transaction processing, that is based on the stated contents of the transaction medium, is included as a candidate of transaction processings that can be selected.

11. The automatic transaction device of claim 1, wherein at a time of insertion of the media into the media insert port, the control section causes a display portion to display a folding method explanation screen that explains a way of folding the transaction medium per type of the transaction medium.

12. The automatic transaction device of claim 1, wherein, at a time of insertion of the media into the media insert port, the control section causes a display portion to display an insert screen that explains a way of inserting the transaction medium into the media insert port.

13. The automatic transaction device of claim 1, wherein, when the discriminating section recognizes the stated contents of the transaction medium, the control section causes a display portion to display a transaction content confirmation screen that, on the basis of the stated contents that the discriminating section recognized, specifies various types of stated items including a stated amount of the transaction medium, and that shows an image of the transaction medium and the stated items in contrast with one another.

14. A computer-readable storage medium storing a program that causes execution by a control section of an automatic transaction device that communicates with a host computer and executes various types of transaction processings and includes a media insert port into which media are inserted, a conveying section that conveys media that have been inserted in the media insert port, a discriminating section that identifies whether the conveyed medium is a bill or is a transaction medium, and, when the medium is identified to be a bill, recognizes a denomination thereof, and, on the other hand, when the medium is identified to be a transaction medium, recognizes stated contents thereof, and the control section that executes a transaction processing,
wherein the program causes the control section to compute a total amount of media that have been identified as bills by the discriminating section, and to execute a transaction processing on the basis of stated contents of a medium that has been identified as the transaction medium by the discriminating section.
